(19) United States
(12) Patent Application Publication
(10) Pub. No.: US 2018/0304875 A1
(43) Pub. Date: Oct. 25, 2018

(54) HYDRAULIC PRESSURE CONTROL DEVICE AND BRAKING SYSTEM

(71) Applicant: HITACHI AUTOMOTIVE SYSTEMS, LTD., Hitachinaka-shi, Ibaraki (JP)

(72) Inventors: Takahiro YAMAGUCHI, Hamura-shi, Tokyo (JP); Chiharu NAKAZAWA, Kawasaki-shi, Kanagawa (JP)

(73) Assignee: HITACHI AUTOMOTIVE SYSTEMS, LTD., Hitachinaka-shi, Ibaraki (JP)

(21) Appl. No.: 15/769,483

(22) PCT Filed: Sep. 2, 2016
(86) PCT No.: PCT/JP2016/075795

§ 371 Date: Apr. 19, 2018

(30) Foreign Application Priority Data
Oct. 26, 2015 (JP) 2015-209968

(51) Int. Cl. B60T 13/68; B60T 8/34; F15B 11/036; F16K 27/02

(52) U.S. Cl. CPC B60T 13/686; B60T 8/344; F16K 31/0675; F16K 27/0209; F15B 11/0365

(57) ABSTRACT

Provided is a hydraulic pressure control device and a braking system, which are capable of increasing a degree of freedom in layout of oil passages inside a housing. The hydraulic pressure control device includes a normally-closed type electromagnetic valve and a normally-open type electromagnetic valve. The normally-closed type electromagnetic valve includes a first valve part arranged so as to extend from a surface of the housing to an inside of the housing, and is configured to close an oil passage when a current is not supplied. The normally-open electromagnetic valve includes a second valve part being arranged so as to extend from the surface of the housing to the inside of the housing and having an axial length set to be equal to an axial length of the first valve part, and is configured to open the oil passage when a current is not supplied.

### TECHNICAL FIELD

The present invention relates to a hydraulic pressure control device and a braking system.

### BACKGROUND ART

As a technology of this type, a technology described in Patent Literature 1 is disclosed. In Patent Literature 1, there is disclosed a technology including normally-open electromagnetic valves and normally-closed electromagnetic valves mounted to a base body (housing) in which flow passages (oil passages) are internally formed, and configured to open/close flows of brake fluid in the flow passages.

### CITATION LIST

### Patent Literature

PTL 1: JP 2008-143202 A1

### SUMMARY OF INVENTION

### Technical Problem

With the technology of Patent Literature 1, the normally-open electromagnetic valves and the normally-closed electromagnetic valves are separately designed due to differences in structure, and are thus different in length of a mounting portion mounted to the housing. Thus, a degree of freedom in layout of oil passages inside the housing is limited, and vehicle mountability may be degraded due to an increase in size of the housing.

The present invention has been made in view of the above-mentioned problem, and has an object to provide a hydraulic pressure control device and a braking system, which are capable of increasing a degree of freedom in layout of oil passages inside a housing, and preventing degradation of vehicle mountability.

### Solution to Problem

According to a first embodiment of the present invention, there is provided a hydraulic pressure control device, including: a normally-closed electromagnetic valve, which includes a first valve part arranged so as to extend from a surface of a housing to an inside of the housing, and is configured to close an oil passage in the housing when a current is not supplied; and a normally-open electromagnetic valve, which includes a second valve part being arranged so as to extend from the surface of the housing to the inside of the housing and having an axial length set to be equal to an axial length of the first valve part, and is configured to open the oil passage in the housing when a current is not supplied.

According to a second embodiment of the present invention, there is provided a hydraulic pressure control device, including: a normally-closed electromagnetic valve, which includes a first valve part arranged so as to extend from a surface of a housing to an inside of the housing, and is configured to close an oil passage in the housing when a current is not supplied; and a normally-open electromagnetic valve, which includes a second valve part being arranged so as to extend from the surface of the housing to the inside of the housing and having an axial length set to be equal to an axial length of the first valve part through inclusion of a common portion having a shape common to the first valve part, and is configured to open the oil passage in the housing when a current is not supplied.

According to a third embodiment of the present invention, there is provided a braking system, including: a first unit including: a stroke simulator, into which brake fluid flowed out from a master cylinder flows, and which is configured to generate a simulated operation reaction force of a brake operation member; and a second unit integrally including: a hydraulic pressure source, which is provided inside a housing, and is configured to generate an operation hydraulic pressure for a wheel cylinder provided to a wheel via an oil passage; an electromagnetic switching valve, which is a normally-closed electromagnetic valve including a first valve part arranged so as to extend from a surface of the housing to an inside of the housing, and being configured to close when a current is not supplied, and is configured to permit an inflow of the brake fluid into the stroke simulator; an electromagnetic shutoff valve, which is a normally-open electromagnetic valve including a second valve part being arranged so as to extend from the surface of the housing to the inside of the housing, including a common portion having a shape common to the first valve part, and being configured to open when a current is not supplied, and is configured to switch a communication state of an oil passage between the master cylinder and the wheel cylinder; and a control unit, which is configured to drive the hydraulic pressure source, the electromagnetic shutoff valve, and the electromagnetic switching valve.

Thus, with the hydraulic pressure control device according to one embodiment of the present invention, the degree of freedom in layout of the oil passages inside the housing can be improved, and the degradation of the vehicle mountability can be prevented.

### BRIEF DESCRIPTION OF DRAWINGS

FIG. 1 is a schematic configuration diagram for illustrating a braking device of a first embodiment of the present invention.

FIG. 2 is a perspective view for illustrating a part of the braking device of the first embodiment.

FIG. 3 is a rear transparent view for illustrating a housing of a second unit of the first embodiment.

FIG. 4 is a right side view for illustrating the second unit transparently through the housing of the first embodiment.

FIG. 5 is a longitudinal sectional view for illustrating a shutoff valve of the first embodiment.

FIG. 6 are exploded perspective views for illustrating the shutoff valve of the first embodiment.

FIG. 7 are views for illustrating a shape of a first filter member of the first embodiment.

FIG. 8 is a longitudinal sectional view for illustrating an SOL/V IN of the first embodiment.

FIG. 9 are exploded perspective views for illustrating the SOL/V IN of the first embodiment.

FIG. 10 is a longitudinal sectional view for illustrating a communication valve of the first embodiment.

FIG. 11 are exploded perspective views for illustrating the communication valve of the first embodiment.

FIG. 12 is a longitudinal sectional view for illustrating an SS/V IN of the first embodiment.

FIG. 13 are exploded perspective views for illustrating the SS/V IN of the first embodiment.

FIG. 14 is a longitudinal sectional view for illustrating an SOL/V OUT of the first embodiment.

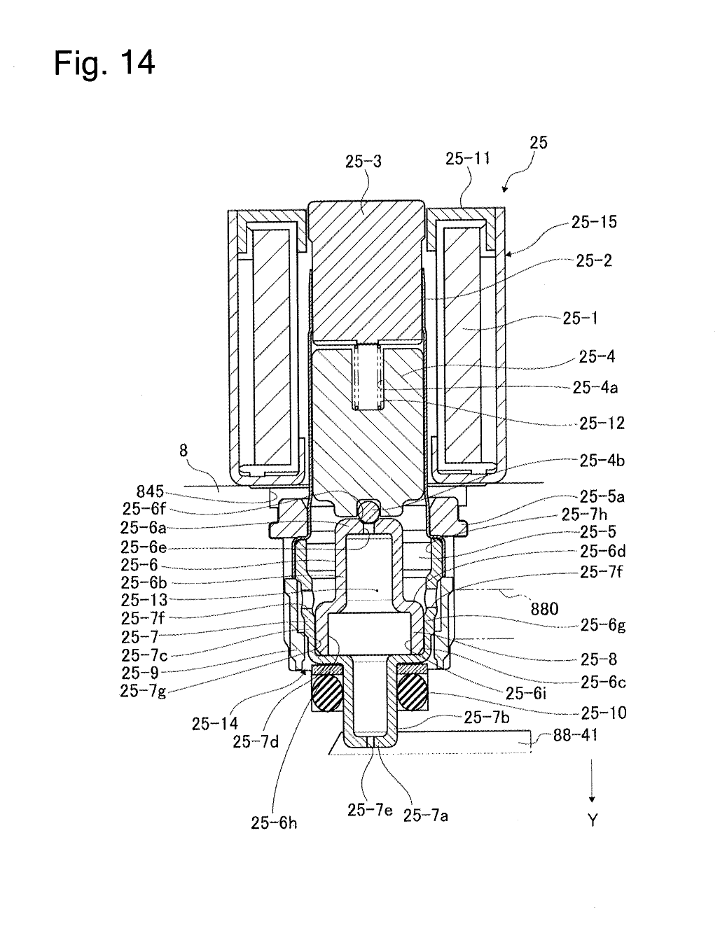

FIG. 15 are views for illustrating a formation method for a seat member of the first embodiment.

FIG. 16 are views for illustrating a formation method for a body member of the first embodiment.

FIG. 17 is a view for illustrating comparison of heights among respective electromagnetic valves of the first embodiment.

FIG. 18 is a cross-sectional view of a SOL/V IN in other embodiments of the present invention.

### DESCRIPTION OF EMBODIMENTS

### First Embodiment

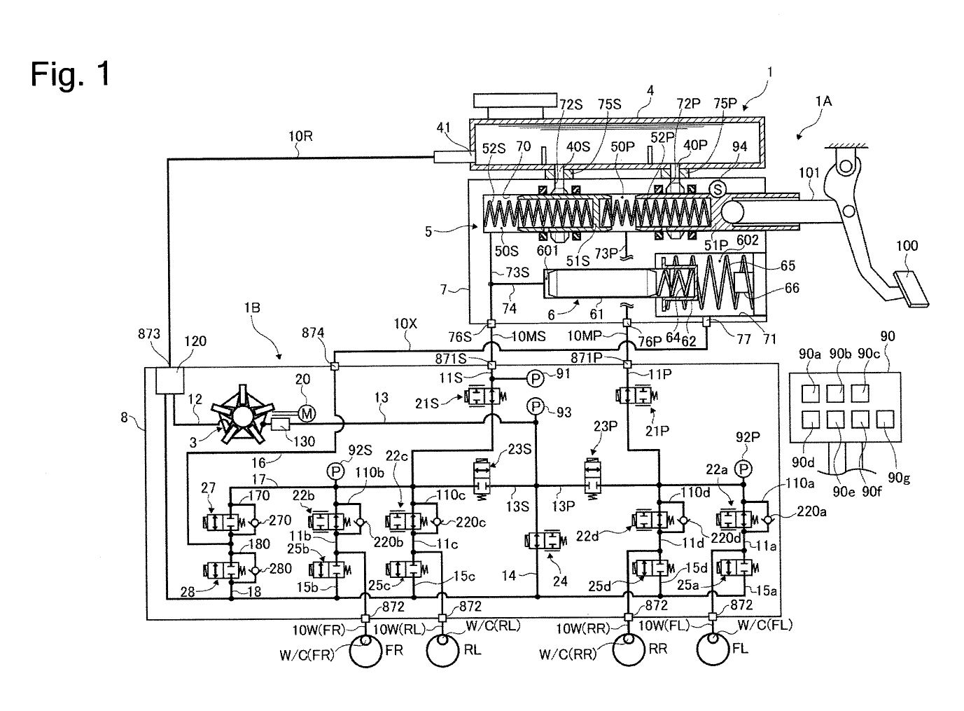

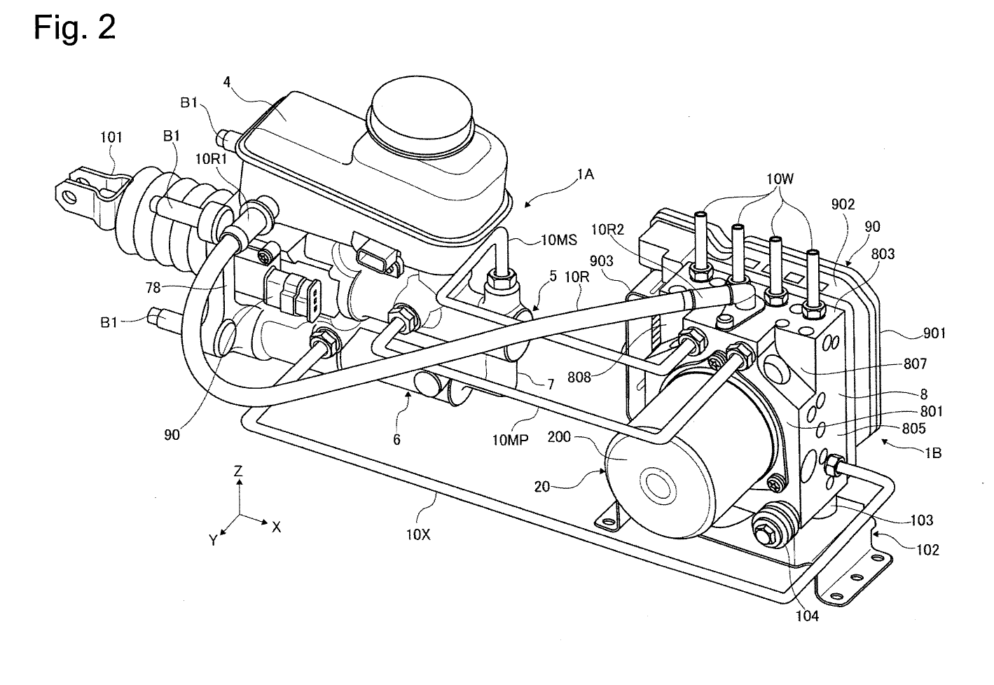

FIG. 1 is a schematic configuration diagram for illustrating a braking device of a first embodiment of the present invention. FIG. 2 is a perspective for illustrating a part of the braking device of the first embodiment.

The braking device 1 is applied to an electrically driven vehicle. The electrically driven vehicle refers to, for example, a hybrid vehicle including a motor generator in addition to an engine, or an electric automobile including only a motor generator as a motor for driving wheels. In the electrically driven vehicle, regenerative braking, that is, breaking of the vehicle by regenerating electric energy from kinetic energy of the vehicle can be performed with use of a regenerative braking device including a motor generator. The braking device 1 is a hydraulic pressure braking device configured to apply friction braking forces through hydraulic pressures to wheels FL to RR of the vehicle. A brake operation unit is provided for each of the wheels FL to RR. The brake operation unit is a hydraulic pressure generation part including a wheel cylinder W/C. The brake operation unit is of, for example, a disc type, and includes a caliper (hydraulic brake caliper). The caliper includes a brake disc and brake pads. The brake disc is a brake rotor rotating integrally with a tire. The brake pads are arranged so as to have predetermined clearances to the brake disc, and are moved by the hydraulic pressures of the wheel cylinder W/C, to thereby come into contact with the brake disc. As a result, a friction braking force is generated. The braking device 1 includes two systems (primary P system and secondary S system) of brake pipes. The brake pipe type is, for example, an X-split pipe type. Other pipe types such as a front/rear-split pipe may be employed. Hereinafter, when a member correspondingly provided to the P system and a member correspondingly provided to the S system are distinguished from one other, suffixes P and S are added to respective reference symbols. The braking device 1 is configured to supply the brake fluid serving as working fluid (working oil) to each of the brake operation units through the brake pipes, to thereby generate hydraulic pressures (brake hydraulic pressures) in the wheel cylinders W/C. As a result, a hydraulic pressure braking force is applied to each of the wheels FL to RR.

The braking device 1 includes a first unit 1A and a second unit 1B. The first unit 1A and the second unit 1B are provided in a motor room isolated from a cabin of the vehicle, and are connected to each other by a plurality of pipes. The plurality of pipes include master cylinder pipes 10M (primary pipe 10MP and secondary pipe 10MS), wheel cylinder pipes 10W, a back pressure pipe 10X, and a suction pipe 10R. Each of the pipes 10M, 10W, and 10X other than the suction pipe 10R is a brake pipe made of metal (metal pipe), specifically, for example, a double-wound steel pipe. Each of the pipes 10M, 10W, and 10X has straight portions and bent portions, and is arranged between ports while the direction is changed at the bent portions. Both ends of each of the pipes 10M, 10W, and 10X include flared male pipe joints. The suction pipe 10R is a brake hose (hose pipe) made of a material such as rubber so as to be flexible. Ends of the suction pipe 10R are connected to a port 873 and the like by nipples 10R1 and 10R2. The nipples 10R1 and 10R2 are resin connection members including pipe portions.

A brake pedal 100 is a brake operation member configured to receive an input of a brake operation by a driver. A pushrod 101 is connected to the brake pedal 100 in a rotatable manner. The first unit 1A is a brake operation unit mechanically connected to the brake pedal 100, and is a master cylinder unit including a master cylinder 5. The first unit 1A includes a reservoir tank 4, a housing 7, the master cylinder 5, a stroke sensor 94, and a stroke simulator 6. The reservoir tank 4 is a brake fluid source for reserving the brake fluid, and is a low-pressure part opened to the atmospheric pressure. Supplement ports 40 and a supply port 41 are formed in the reservoir tank 4. The suction pipe 10R is connected to the supply port 41. The housing 7 is a casing for accommodating (build in) the master cylinder 5 and the stroke simulator 6 therein. A cylinder 70 for the master cylinder 5, a cylinder 71 for the stroke simulator 6, and a plurality of oil passages (liquid passages) are formed in the housing 7. The plurality of oil passages include supplement oil passages 72, supply oil passages 73, and a positive pressure oil passage 74. A plurality of ports are formed in the housing 7, and those ports are opened in outer surfaces of the housing 7. The plurality of ports include supplement ports 75P and 75S, supply ports 76, and a back pressure port 77. The supplement ports 75P and 75S are connected to supplement ports 40P and 40S of the reservoir tank 4, respectively. The master cylinder pipes 10M are connected to the supply ports 76, and the back pressure pipe 10X is connected to the back pressure port 77. One end of the supplement oil passage 72 is connected to the supplement port 75, and another end is connected to the cylinder 70.

The master cylinder 5 is a first hydraulic pressure source capable of supplying an operation hydraulic pressure to the wheel cylinders W/C, is connected to the brake pedal 100 by the pushrod 101, and is operated in accordance with an operation on the brake pedal 100 by the driver. The master cylinder 5 includes a piston 51 which is moved in an axial direction in accordance with the operation on the brake pedal 100. The piston 51 is accommodated in the cylinder 70, and defines hydraulic pressure chambers 50. The master cylinder 5 is of a tandem type, and includes a primary piston 51P connected to the pushrod 101 and a secondary piston 51S of a free piston type in series as pistons 51. A primary chamber 50P is defined by the pistons 51P and 51S, and a secondary chamber 50S is defined by the secondary piston 51S. One end of the supply oil passage 73 is connected to the hydraulic pressure chamber 50, and another end is connected to the supply port 76. Each of the hydraulic pressure chambers 50P and 50S is supplemented with the brake fluid from the reservoir tank 4 to generate a hydraulic pressure (master cylinder hydraulic pressure) through the movement of the piston 51. A coil spring 52P serving as a return spring is interposed between both the pistons 51P and 51S in the primary chamber 50P. A coil spring 52S serving as a return spring is interposed between a bottom portion of the cylinder 70 and the piston 51S in the secondary chamber 50S. A stroke sensor 94 is configured to detect a stroke (pedal stroke) of the primary piston 51P. A magnet for detection is provided in the primary piston 51P, and a sensor main body is mounted to an outer surface of the housing 7 of the first unit 1A.

The stroke simulator 6 is operated in accordance with the brake operation by the driver, and is configured to apply a reaction force and a stroke to the brake pedal 100. The stroke simulator 6 includes a piston 61, a positive pressure chamber 601 and a back pressure chamber 602 defined by the piston 61, and elastic bodies (first spring 64, second spring 65, and damper 66) configured to urge the piston 61 in a direction in which the volume of the positive pressure chamber 601 decreases. A retainer member 62 having a bottomed tubular shape is interposed between the first spring 64 and the second spring 65. One end of a positive pressure oil passage 74 is connected to a supply oil passage 73S on the secondary side, and another end is connected to the positive pressure chamber 601. The pedal stroke is generated by inflow of the brake fluid from the master cylinder 5 (secondary chamber 50S) to the positive pressure chamber 601 in accordance with the brake operation by the driver, and a reaction force against a brake operation by the driver is generated by the urging force of the elastic body. The first unit 1A does not include an engine negative pressure booster configured to boost the brake operation force through use of an intake negative pressure generated in the engine of the vehicle.

The second unit 1B is a hydraulic pressure control device provided between the first unit 1A and the brake operation units. The second unit 1B is connected to the primary chamber 50P by the primary pipe 10MP, is connected to the secondary chamber 50S by the secondary pipe 10MS, is connected to the wheel cylinders W/C by the wheel cylinder pipes 10W, and is connected to the back pressure chamber 602 by the back pressure pipe 10X. Moreover, the second unit 1B is connected to the reservoir tank 4 by the suction pipe 10R. The second unit 1B includes a housing 8, a motor 20, a pump 3, a plurality of electromagnetic valves 21, a plurality of hydraulic pressure sensors 91, and an electronic control unit 90 (hereinafter referred to as “ECU”). The housing 8 is a casing for accommodating (build in) the pump 3, valve bodies of the electromagnetic valves 21, and the like therein. Circuits (brake hydraulic pressure circuits) of the two systems (P system and S system), through which the brake fluid circulates, are formed of a plurality of oil passages in the housing 8. The plurality of oil passages include supply oil passages 11, a suction oil passage 12, discharge oil passages 13, a pressure regulating oil passage 14, pressure reducing oil passages 15, a back pressure oil passage 16, a first simulator oil passage 17, and a second simulator oil passage 18. Moreover, a reservoir (internal reservoir) 120, which is a liquid reservoir, and a damper 130 are formed in the housing 8. A plurality of ports are formed in the housing 8, and those ports are opened in outer surfaces of the housing 8. The plurality of ports include master cylinder ports 871 (primary ports 871P and secondary ports 871S), a suction port 873, a back pressure port 874, and wheel cylinder ports 872. The primary pipe 10MP, the secondary pipe 10MS, the suction pipe 10R, the back pressure pipe 10X, and the wheel cylinder pipes 10W are mounted and connected to the primary port 871P, the secondary port 871S, the suction port 873, the back pressure port 874, and the wheel cylinder ports 872, respectively.

The motor 20 is an electric motor of a rotation type, and includes a rotation shaft configured to drive the pump 3. The motor 20 may be a brushless motor or a brush motor. The motor 20 includes a resolver configured to detect a rotation angle of the rotation shaft. The resolver functions as a number-of-revolution sensor configured to detect the number of revolutions of the motor 20. The pump 3 is a hydraulic pressure source capable of supplying an operation hydraulic pressure to the wheel cylinders W/C, and includes five pump parts driven by the single motor 20. The pump 3 is used for the S system and the P system in common. Each of the electromagnetic valves 21 and the like is a solenoid valve configured to operate in accordance with a control signal. A valve body is configured to perform a stroke in accordance with a current supply to the solenoid to switch opening and closing of an oil passage (open/close the oil passage). Each of the electromagnetic valves 21 and the like controls the communication state of the circuit and adjusts the circulation state of the brake fluid to generate a control hydraulic pressure. The plurality of electromagnetic valves 21 and the like include shutoff valves 21, pressure boosting valves (hereinafter referred to as “SOL/V IN”) 22, communication valves 23, a pressure regulating valve 24, pressure reducing valves (hereinafter referred to as “SOL/V OUT”) 25, a stroke simulator-in valve (hereinafter referred to as “SS/V IN”) 27, and a stroke simulator-out valve (hereinafter referred to as “SS/V OUT”) 28. Each of the shutoff valve 21, the SOL/V IN 22, and the regulating valve 24 is a normally-open electromagnetic valve which is opened in a non-current supply state. Each of the communication valve 23, the pressure reducing valve 25, the SS/V IN 27, and the SS/V OUT 28 is a normally-closed electromagnetic valve, which is closed in the non-current supply state. Each of the shutoff valve 21, the SOL/V IN 22, and the pressure regulating valve 24 is a proportional control valve which has an opening degree adjusted in accordance with the current supplied to the solenoid. Each of the communication valve 23, the pressure reducing valve 25, the SS/V IN 27, and the SS/V OUT 28 is an ON/OFF valve which is subjected to binary switching control between an opening state and a closing state. A proportional control valve may be used for each of those valves. Each of the hydraulic pressure sensor 91 and the like is configured to detect a discharge pressure of the pump 3 or a master cylinder hydraulic pressure. The plurality of hydraulic pressure sensors include a master cylinder hydraulic pressure sensor 91, a discharge pressure sensor 93, and wheel cylinder hydraulic pressure sensors 92 (primary pressure sensor 92P and secondary pressure sensor 92S).

Now, based on FIG. 1, description is given of the brake hydraulic pressure circuit of the second unit 1B. For members corresponding to the respective wheels FL to RR, suffixes of “a” to “d” are added to respective reference symbols for proper distinction. One end side of a supply oil passage 11P is connected to the primary port 871P. Another end side of the supply oil passage 11P is branched into an oil passage 11a for a front left wheel and an oil passage 11d for a rear right wheel. Each of the oil passages 11a and 11d is connected to the corresponding wheel cylinder port 872. One end side of a supply oil passage 11S is connected to the secondary port 871S. Another end side of the supply oil passage 11S is branched into an oil passage 11b for the front right wheel and an oil passage 11c for the rear left wheel. Each of the oil passages 11b and 11c is connected to the corresponding wheel cylinder port 872. The shutoff valve 21 is provided on the one end side of each of the supply oil passages 11. The SOL/V IN 22 is provided on the another end side of each of the oil passages 11. A bypass oil passage 110 configured to bypass the SOL/V IN 22 is provided in parallel with each of the oil passages 11. A check valve 220 is provided in the bypass oil passage 110. The check valve 220 permits only a flow of the brake fluid from the wheel cylinder port 872 to the master cylinder port 871.

The suction oil passage 12 connects the reservoir 120 and suction ports 823 of the pump 3 to each other. One end side of the discharge oil passage 13 is connected to discharge ports 821 of the pump 3. Another end side of the discharge oil passage 13 is branched into the oil passage 13P for the P system and the oil passage 13S for the S system. Each of the oil passages 13P and 13S connects the shutoff valve 21 in the supply oil passage 11 and the SOL/V IN 22 to each other. A damper 130 is provided on the one end side of the discharge oil passage 13. The communication valve 23 is provided in each of the oil passages 13P and 13S on another end side. The respective oil passages 13P and 13S function as communication passages for connecting the supply oil passage 11P in the P system and the supply oil passage 11S in the S system to each other. The pump 3 is connected to the respective wheel cylinder ports 872 by the communication passages (discharge oil passages 13P and 13S) and the supply oil passages 11P and 11S. The pressure regulating oil passage 14 connects an intermediate portion of the discharge oil passages 13 between the damper 130 and the communication valves 23 and the reservoir 120 to each other. The pressure regulating valve 24 is provided in the pressure regulating passage 14. The pressure reducing oil passage 15 connects an intermediate portion between the SOL/V IN 22 in each of the oil passages 11a to 11d of the supply oil passage 11 and the wheel cylinder port 872 and the reservoir 120 to each other. The SOL/V OUT 25 is provided in the pressure reducing oil passage 15.

One end side of the back pressure oil passage 16 is connected to the back pressure port 874. Another end side of the back pressure oil passage 16 is branched into a first simulator oil passage 17 and a second simulator oil passage 18. The first simulator oil passage 17 connects the shutoff valve 21S in the supply oil passage 11S and the SOL/V IN 22b and 22c to each other. The SS/V IN 27 is provided in the first simulator oil passage 17. A bypass oil passage 170 configured to bypass the SS/V IN 27 is provided in parallel with the first simulator oil passages 17. A check valve 270 is provided in the bypass oil passage 170. The check valve 270 permits only a flow of the brake fluid from the back pressure oil passage 16 to the supply oil passage 11S. The second simulator oil passage 18 is connected to the reservoir 120. The SS/V OUT 28 is provided in the second simulator oil passage 18. A bypass oil passage 180 configured to bypass the SS/V OUT 28 is provided in parallel with the second simulator oil passages 18. A check valve 280 is provided in the bypass oil passage 180. The check valve 280 permits only a flow of the brake fluid from the reservoir 120 to the back pressure oil passage 16.

A hydraulic pressure sensor 91 configured to detect a hydraulic pressure (hydraulic pressure in the positive pressure chamber 601 of the stroke simulator 6, or the master cylinder hydraulic pressure) at an intermediate position between the shutoff valve 21S in the supply oil passage 11S and the secondary port 871S is provided at this position. A hydraulic pressure sensor 92 configured to detect a hydraulic pressure (corresponding to the wheel cylinder hydraulic pressure) at a point between the shutoff valve 21 in the supply oil passage 11 and the SOL/V INs 22 is provided at this point. A hydraulic pressure sensor 93 configured to detect a hydraulic pressure (pump discharge pressure) at a point between the damper 130 in the discharge oil passage 13 and the communication valves 23 is provided at this point.

Hereinafter, for convenience of description, a three-dimensional Cartesian coordinate system including an X axis, a Y axis, and a Z axis is given. In a state in which the first unit 1A and the second unit 1B are mounted to the vehicle, a Z-axis direction is the vertical direction, and a positive side in the Z-axis direction is a top side in the vertical direction. An X-axis direction is a front/rear direction of the vehicle, and a positive side in the X-axis direction is the vehicle front side. A Y-axis direction is a lateral direction of the vehicle.

In the first unit 1A, the pushrod 101 extends from the end on a negative side in the X-axis direction, which is connected to the brake pedal 100, to the positive side in the X-axis direction. A rectangular flange part 78 is provided at an end on the negative side in the X-axis direction of the housing 7. Bolt holes are formed in four corners of the flange part 78. A bolt B1 passes through the bolt hole for fixing and mounting the first unit 1A to a dash panel on a vehicle body side. The reservoir tank 4 is provided on the positive side in the Z-axis direction of the housing 7.

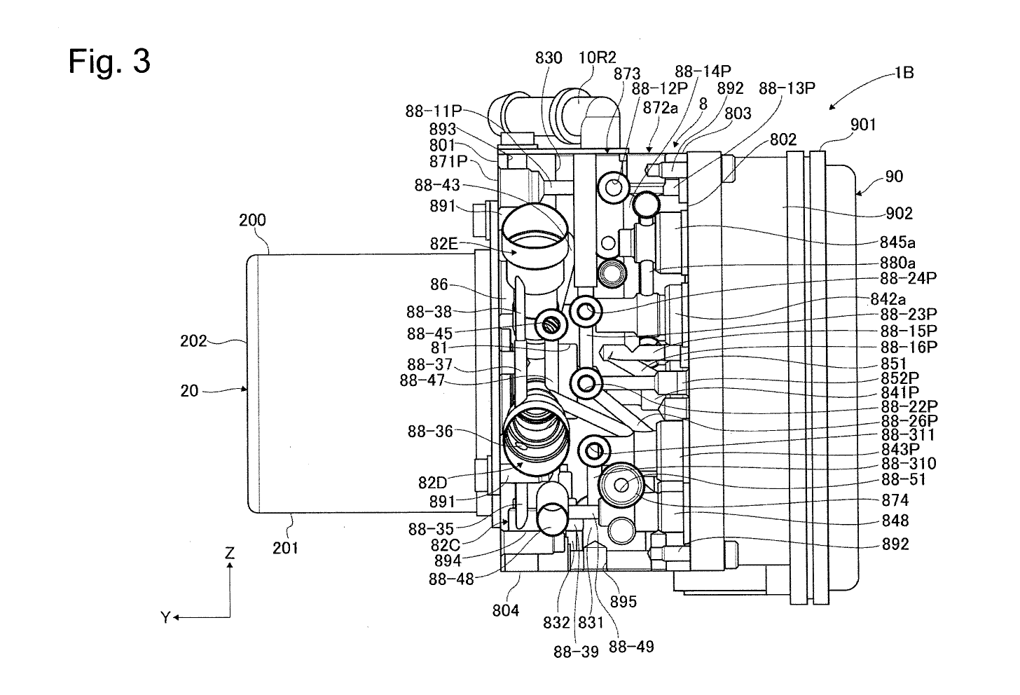

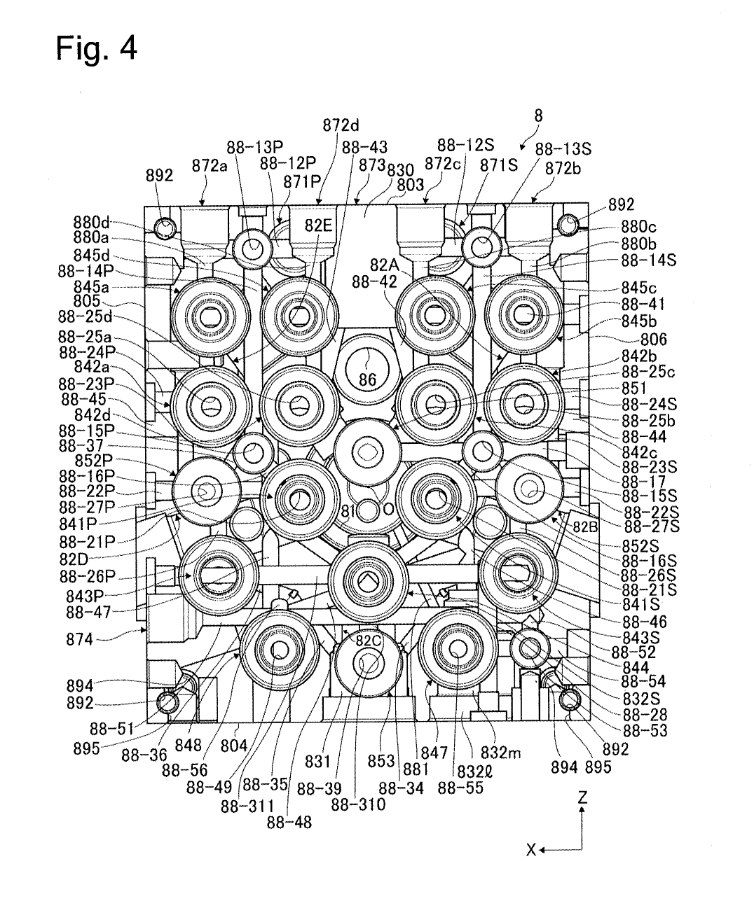

The housing 8 is a block having an approximately rectangular parallelepiped shape made of aluminum alloy as a material in the second unit 1B. Outer surfaces of the housing 8 include a front surface 801, a rear surface 802, a top surface 803, a bottom surface 804, a right side surface 805, and a left side surface 806 (refer to FIG. 3 and FIG. 4). The recessed parts 807 and 808 are formed at the corners of the housing 8 on the front surface 801 side and the top surface 803 side. The housing 8 is fixed to a vehicle body side (a bottom surface of the motor room) via the mount 102. Insulators 103 and 104 are interposed between the housing 8 and the mount 102. The motor 20 is arranged on the front surface 801 of the housing 8, and the motor housing 200 is mounted. An ECU 90 is mounted to the rear surface 802 of the housing 8. In other words, the ECU 90 is integrally provided to the housing 8. The ECU 90 includes a control board (not shown) and a control unit housing (case) 901. The control board is configured to control current supply states to the motor 20 and the solenoids such as the electromagnetic valves 21. Various sensors configured to detect a motion state of the vehicle such as an acceleration sensor configured to detect an acceleration of the vehicle and an angular velocity sensor configured to detect an angular velocity (yaw rate) of the vehicle may be mounted on the control board. Moreover, a complex sensor (combined sensor) in which those sensors are combined as a unit may be mounted on the control board. The control board is accommodated in the case 901. The case 901 is a cover member fixed to the rear surface 802 of the housing 8 through fastening with bolts.

The case 901 is a cover member made of a resin material, and includes a board accommodating part 902 and a connector part 903. The board accommodating part 902 is configured to accommodate the control board and a part of the solenoids such as the electromagnetic valves 21. The connector part 903 is arranged on a positive side in the X-axis direction with respect to the terminals and the conductive members in the board accommodating part 902, and protrudes on a positive side in the Y-axis direction of the board accommodating part 902. The connector part 903 is arranged more or less on the outside (on the positive side in the X-axis direction) with respect to the left side surface 806 of the housing 8 as viewed from the X-axis direction. Terminals of the connector part 903 are exposed toward the positive side in the Y-axis direction, and extend to a negative side in the Y-axis direction so as to be connected to the control board. Each of the terminals (exposed toward the positive side in the Y-axis direction) of the connector part 903 can be connected to external devices and the stroke sensor 94 (hereinafter referred to as “external devices and the like”). Electrical connections between the external devices and the like and the control board (ECU 90) are established when another connector to be connected to the external devices and the like is inserted into the connector part 903 from the positive side in the Y-axis direction. Moreover, a current is supplied from an external power supply (battery) to the control board via the connector part 903. The conductive members function as a connection part for electrically connecting the control board and (a stator of) the motor 20 to each other, and a current is supplied to (the stator of) the motor 20 from the control board via the conductive members.

FIG. 3 to FIG. 4 are views for transparently illustrating passages, recessed parts, and holes of the housing 8. FIG. 3 is a rear transparent view for illustrating the housing 8 as viewed from the negative side in the Y-axis direction. FIG. 4 is a right side view in which the second unit 1B is viewed from the positive side in the X-axis direction, for illustrating the passages and the like transparently though the housing 8.

The housing 8 includes a cam accommodating hole 81, the plurality of (five) cylinder accommodating holes 82A to 82E, a reservoir chamber 830, a damper chamber 831, a liquid reservoir chamber 832, a plurality of valve body accommodating holes (mounting hole) 84x (x represents 1 to 5, 7, and 8), a plurality of sensor accommodating holes 85x (x represents 1 to 3), a power supply hole 86, a plurality of ports 87x (x represents 1 to 4), a plurality of oil passage holes 88x (x represents −1y to −5y, 0, and 1), and a plurality of bolt holes (pin holes) 89x (x represents 1 to 5). Those holes and ports are formed by drills and the like. The cam accommodating hole 81 has a bottomed tubular shape extending in the Y-axis direction, and is opened in the front surface 801. An axial center O of the cam accommodating hole 81 is approximately at a center in the X-axis direction on the front surface 801, and is present more or less on the negative side in the Z-axis direction with respect to a center in the Z-axis direction.

The cylinder accommodating hole 82 has a stepped tubular shape, and extends in a radial direction (radiation direction about the axial center O) of the cam accommodating hole 81. The cylinder accommodating holes 82 are formed approximately equiangularly (at approximately equal intervals) in a circumferential direction about the axial center O. An angle formed by the axial centers of the cylinder accommodating holes 82 which are adjacent to each other in the circumferential direction of the axial center O is approximately 72° (in a predetermined range including 72°). The plurality of cylinder accommodating holes 82A to 82E are arranged in a single row along the Y-axis direction, and are formed on the positive side in the Y-axis direction of the housing 8. The reservoir chamber 830 has a bottomed tubular shape, which has an axial center extending in the Z-axis direction, and is opened approximately at a center in the X-axis direction and at a center in the Y-axis direction on the top surface 803. The reservoir chamber 830 is arranged in a region surrounded by the master cylinder ports 871 and the wheel cylinder ports 872. (A bottom part on the negative side in the Z-axis direction of) the reservoir chamber 830 is arranged on the positive side in the Z-axis direction with respect to the suction ports 823 of the respective cylinder accommodating holes 82. The reservoir chamber 830 is formed in a region between the cylinder accommodating holes 82A and 82E which are adjacent to each other in the circumferential direction of the axial center O. The cylinder accommodating holes 82A to 82E and the reservoir chamber 830 partially overlap with each other in the Y-axis direction (as viewed from the X-axis direction). The damper chamber 831 has a bottomed tubular shape, which has an axial center extending in the Z-axis direction, and is opened approximately at the center in the X-axis direction and more or less on the negative side in the Y-axis direction with respect to the center in the Y-axis direction on the bottom surface 804. The damper chamber 831 is arranged on the negative side in the Z-axis direction with respect to the cam accommodating hole 81. The liquid reservoir chamber 832 has a stepped bottomed tubular shape, which has an axial center extending in the Z-axis direction, and is opened on the negative side in the X-axis direction and the positive side in the Y-axis direction in the bottom surface 804. The liquid reservoir chamber 832 is arranged on the negative side in the Z-axis direction with respect to the cam accommodating hole 81. The liquid reservoir chamber 832 has a large-diameter part 8321 on a side closer to the bottom surface 804 (negative side in the Z-axis direction), a small-diameter part 832s on a side farther from the bottom surface 804 (positive side in the Z-axis direction), and a medium-diameter part 832m between the large-diameter part 8321 and the small-diameter part 832s.

Each of the plurality of the valve body accommodating holes 84x has a stepped tubular shape, extends in the Y-axis direction, and is opened in the rear surface 802. Each of the plurality of the valve body accommodating holes 84x has a large-diameter part on a side closer to the rear surface 802 (negative side in the Y-axis direction), a small-diameter part on a side farther from the rear surface 802 (outer side in the positive side in the Y-axis direction), and a medium-diameter part between the large-diameter part and the small-diameter part. The plurality of valve body accommodating holes 84x are arranged in a single row along the Y-axis direction, and are formed on the negative side in the Y-axis direction of the housing 8. The cylinder accommodating holes 82 and the valve body accommodating holes 84x are arrayed along the Y-axis direction. The plurality of the valve body accommodating holes 84x at least partially overlap with the cylinder accommodating holes 82 as viewed from the Y-axis direction. Most of the plurality of the valve body accommodating holes 84x are contained in a circle connecting the ends on the large-diameter part side (side farther from the axial center O) of the plurality of cylinder accommodating holes 82 to each other. In other words, an outer periphery of this circle and the valve body accommodating holes 84x at least partially overlap with each other.

The SOL/V OUT 25 is accommodated in the SOL/V OUT accommodating hole 845. The bypass oil passage 1100 and the check valve 220 are formed of, for example, a seal member, which has a cup shape and is provided in the hole 842. The SOL/V OUT accommodating holes 845a to 845d are arranged in a single row in the X-axis direction on the positive side in the Z-axis direction of the rear surface 802. Two SOL/V OUT accommodating holes in the P system are formed on the positive side in the X-axis direction. Two SOL/V OUT accommodating holes in the S system are formed on the negative side in the X-axis direction. In the P system, the hole 845a is formed on the positive side in the X-axis direction with respect to the hole 845d. In the S system, the hole 845b is formed on the negative side in the X-axis direction with respect to the hole 845c. The SOL/V IN 22 is accommodated in the SOL/V IN accommodating hole 842. The SOL/V IN accommodating holes 842a to 842d are arranged in a single row in the X-axis direction more or less on the positive side in the Z-axis direction with respect to the axial center O (or at the center in the Z-axis direction of the housing 8). The SOL/V IN accommodating hole 842 is adjacent to the SOL/V OUT accommodating hole 845 on the negative side in the Z-axis direction. Two SOL/V IN accommodating holes in the P system are formed on the positive side in the X-axis direction. Two SOL/V IN accommodating holes in the S system are formed on the negative side in the X-axis direction. In the P system, the hole 842a is formed on the positive side in the X-axis direction with respect to the hole 842d. In the S system, the hole 842b is formed on the negative side in the X-axis direction with respect to the hole 842c. The axial centers of the holes 842a to 842d are approximately at the same positions in the X-axis direction as the axial centers of the holes 845a to 845d, respectively.

The shutoff valve 21 is accommodated in the shutoff valve accommodating hole 841. The shutoff valve accommodating holes 841P and 841S are arrayed in the X-axis direction more or less on the negative side in the Z-axis direction with respect to the center in the Z-axis direction of the housing 8. The hole 841P is formed more or less on the positive side in the X-axis direction with respect to a center in the X-axis direction. The hole 841S is formed more or less on the negative side in the X-axis direction with respect to the center in the X-axis direction. Axial centers of the holes 841P and 841S are slightly on the negative side in the Z-axis direction with respect to the axial center O, and are at approximately the same positions in the X-axis direction as the axial centers of the holes 842d and 842c. The communication valve 23 is accommodated in the communication valve accommodating hole 843. The communication valve accommodating holes 843P and 843S are arrayed in the X-axis direction on the negative side in the Z-axis direction with respect to the axial center O. The communication valve accommodating hole 843 is adjacent to the shutoff valve accommodating hole 841 on the negative side in the Z-axis direction. The hole 843P is formed on the positive side in the X-axis direction with respect to the center in the X-axis direction. The hole 843S is formed on the negative side in the X-axis direction with respect to the center in the X-axis direction. An axial center of the hole 843P is slightly on the negative side in the X-axis direction with respect to the axial center of the hole 842a. An axial center of the hole 843S is slightly on the positive side in the X-axis direction with respect to the axial center of the hole 842b. An end on the positive side in the Z-axis direction of the opening of the communication valve accommodating hole 843 overlaps with an end on the negative side in the Z-axis direction of the opening of the shutoff valve accommodating hole 841 in the Z-axis direction (as viewed from the X-axis direction) on the rear surface 802. The pressure regulating valve 24 is accommodated in the pressure regulating valve accommodating hole 844. The pressure regulating valve accommodating hole 844 is formed on the negative side in the Z-axis direction with respect to the axial center O, and is formed at approximately the same position in the X-axis direction as the axial center O. The pressure regulating valve accommodating hole 844 is formed between the communication valve accommodating holes 843P and 843S in the X-axis direction, and is adjacent to the shutoff valve accommodating holes 841 on the negative side in the Z-axis direction. The pressure regulating valve accommodating hole 844 is at approximately the same position in the Z-axis direction as the communication valve accommodating holes 843, and is arrayed together with the holes 843P and 843S in a single row in the X-axis direction. Both ends in the X-axis direction of the opening of the pressure regulating valve accommodating hole 844 overlap with ends in the X-axis direction of the openings of the shutoff valve accommodating holes 841 in the X-axis direction (as viewed from the Z-axis direction) on the rear surface 802.

The SS/V IN 27 is accommodated in the SS/V IN accommodating hole 847. The bypass oil passage 170 and the check valve 270 are each formed of, for example, a seal member, which has a cup shape and is provided in the hole 847. The SS/V OUT 28 is accommodated in the SS/V OUT accommodating hole 848. The bypass oil passage 180 and the check valve 280 are formed of a seal member, which has a cup shape and is provided in the hole 848. The holes 847 and 848 are arrayed in the X-axis direction on the negative side in the Z-axis direction with respect to the axial center O. The holes 847 and 848 are adjacent to the communication valve accommodating holes 843 and the pressure regulating valve accommodating holes 844 on the negative side in the Z-axis direction. An axial center of the hole 848 is positioned between the axial center of the hole 844 and the axial center of the hole 843P in the X-axis direction, and is positioned more or less on the positive side in the X-axis direction with respect to an axial center of the hole 841P. An end on the positive side in the X-axis direction of the opening of the hole 848 overlaps with an end on the negative side in the X-axis direction of the opening of the hole 843P in the X-axis direction (as viewed from the Z-axis direction) on the rear surface 802. An end on the positive side in the Z-axis direction of the opening of the hole 848 overlaps with an end on the negative side in the Z-axis direction of the opening of the hole 843P in the Z-axis direction (as viewed from the Y-axis direction). An axial center of the hole 847 is positioned between the axial center of the hole 844 and the axial center of the hole 843S in the X-axis direction, and is positioned more or less on the negative side in the X-axis direction with respect to an axial center of the hole 841S. An end on the negative side in the X-axis direction of the opening of the hole 847 overlaps with an end on the positive side in the X-axis direction of the opening of the hole 843S in the X-axis direction (as viewed from the Z-axis direction) on the rear surface 802. An end on the positive side in the Z-axis direction of the opening of the hole 847 overlaps with an end on the negative side in the Z-axis direction of the opening of the hole 843S in the Z-axis direction (as viewed from the Y-axis direction).

Each of the plurality of sensor accommodating holes 85x has a bottomed tubular shape, which has an axial center extending in the Y-axis direction, and is opened in the rear surface 802. A pressure sensitive part of the master cylinder pressure sensor 91 is accommodated in a master cylinder pressure sensor accommodating hole 851. The hole 851 is formed at approximately at the center in the X-axis direction and approximately at the center in the Z-axis direction of the housing 8, and an axial center of the hole 851 is more or less on the positive side in the Z-axis direction with respect to the axial center O. The holes 851 are formed in a region surrounded by the holes 842, 845, 841P, and 841S. A pressure sensitive part of the discharge pressure sensor 93 is accommodated in a discharge pressure sensor accommodating hole 853. The hole 853 is formed approximately at the center in the X-axis direction and on the negative side in the Z-axis direction of the housing 8, and an axial center of the hole 853 is slightly on the negative side in the Z-axis direction with respect to the holes 847 and 848. The hole 853 is formed in a region surrounded by the holes 844, 847, and 848. A pressure sensitive part of the wheel cylinder hydraulic pressure sensor 92 is accommodated in a wheel cylinder hydraulic pressure sensor accommodating hole 852. The holes 852P and 852S are arrayed in the X-axis direction at approximately the same positions in the Z-axis direction as the axial center O. The hole 852P is formed on the positive side in the X-axis direction with respect to the center in the X-axis direction. The hole 852S is formed on the negative side in the X-axis direction with respect to the center in the X-axis direction. An axial center of the hole 852P is slightly on the positive side in the X-axis direction with respect to the axial center of the hole 842a. An axial center of the hole 852S is slightly on the negative side in the X-axis direction with respect to the axial center of the hole 842b. The hole 852 is formed in a region surrounded by the holes 841, 842, and 843. The power supply hole 86 has a tubular shape, and passes through the housing 8 (between the front surface 801 and the rear surface 802) in the Y-axis direction. The hole power supply 86 is formed approximately at the center in the X-axis direction and on the positive side in the Z-axis direction of the housing 8. The hole power supply 86 is formed in a region surrounded by the holes 842c and 842d and the holes 845c and 845d, and in a region between the cylinder accommodating holes 82A and 82E which are adjacent to each other.

Each of the master cylinder ports 871 has a bottomed tubular shape, which has an axial center extending in the Y-axis direction, and is opened in a portion at an end on the positive side in the Z-axis direction between the recessed parts 807 and 808 on the front surface 801. A primary port 871P is formed on the positive side in the X-axis direction. The secondary port 871S is formed on the negative side in the X-axis direction. Both the ports 871P and 871S are arrayed in the X-axis direction, and are on both sides of the reservoir chamber 830 and a bolt hole 891 in the X-axis direction (as viewed from the Y-axis direction). The ports 871P and 871S are formed respectively between the reservoir chamber 830 and the cylinder accommodating holes 82A and 82E in the circumferential direction of the axial center O (as viewed from the Y-axis direction). Openings of the master cylinder ports 871 and an opening of the bolt hole 891 partially overlap with each other in the Z-axis direction (as viewed from the X-axis direction). Each of the wheel cylinder ports 872 has a bottomed tubular shape, which has an axial center extending in the Z-axis direction, and is opened on the negative side in the Y-axis direction (position closer to the rear surface 802 than to the front surface 801) in the top surface 803. The ports 872a to 872d are arranged in a single row in the X-axis direction. Two ports in the P system are formed on the positive side in the X-axis direction. Two ports in the S system are formed on the negative side in the X-axis direction. In the P system, the port 872a is formed on the positive side in the X-axis direction with respect to the port 872d. In the S system, the port 872b is formed on the negative side in the X-axis direction with respect to the port 872c. The ports 872c and 872d are on both sides of the suction port 873 (reservoir chamber 830) as viewed from the Y-axis direction. An opening of each of the ports 872 and the suction port 873 (opening of the reservoir chamber 830) partially overlap with each other in the X-axis direction (as viewed from the Y-axis direction). The opening of each of the ports 872 and an opening of the suction port 873 partially overlap with each other in the Y-axis direction (as viewed from the X-axis direction).

The suction port 873 is the opening of the reservoir chamber 830 on the top surface 803, is formed so as to be directed to the top side in the vertical direction, and is opened on the top side in the vertical direction. The port 873 is opened at a position on a center side in the X-axis direction and on a center side in the Y-axis direction closer to the front surface 801 than the wheel cylinder ports 872 on the top surface 803. The port 873 is formed on the positive side in the Z-axis direction with respect to the suction ports 823 of the cylinder accommodating holes 82A to 82E. The cylinder accommodating holes 82A and 82E are on both sides of the port 873 as viewed from the Y-axis direction. An opening of each of the cylinder accommodating holes 82A and 82E and the port 873 partially overlap with each other in the Y-axis direction (as viewed from the X-axis direction). The back pressure port 874 has a bottomed tubular shape, which has an axial center extending in the X-axis direction, and is opened more or less on the negative side in the Y-axis direction and on the negative side in the Z-axis direction with respect to the axial center O on the right side surface 805. The axial center of the port 874 is positioned between an axial center of the communication valve accommodating hole 843 and an axial center of the SS/V OUT accommodating hole 848 in the Z-axis direction.

The plurality of oil holes 88x include first to fifth hole groups 88-1y to 88-5y and oil passage holes 880 and 881. The first hole group 88-1y connects the master cylinder ports 871, the shutoff valve accommodating holes 841, and the master cylinder pressure sensor accommodating hole 851 to one another. The second hole group 88-2y connects the shutoff valve accommodating holes 841, the communication valve accommodating holes 843, the SOL/V IN accommodating holes 842, the SS/V IN accommodating hole 847, and the wheel cylinder pressure sensor accommodating holes 852 to one another. The third hole group 88-3y connects the discharge ports 821 of the cylinder accommodating holes 82, the communication valve accommodating holes 843, the pressure regulating valve accommodating holes 844, and the discharge pressure sensor accommodating hole 853 to one another. The fourth hole group 88-4y connects the reservoir chamber 830, the suction ports 823 of the cylinder accommodating holes 82, the SOL/V OUT accommodating holes 845, the SS/V OUT accommodating hole 848, and the pressure regulating valve accommodating hole 844 to one another. The fifth hole group 88-5y connects the back pressure port 874, the SS/V IN accommodating hole 847, and the SS/V OUT accommodating hole 848 to one another. Each of the oil holes 880 connects the SOL/V IN accommodating hole 842 and the wheel cylinder port 872 to each other. The oil passage hole 881 connects the cam accommodating hole 81 and the liquid reservoir chamber 832 to each other.

The first hole group 88-1y includes first holes 88-11 to seventh holes 88-17. First, description is given of the P system. The first hole 88-11P extends from a bottom part of the primary port 871P to the negative side in the Y-axis direction. The second hole 88-12P extends from the right side surface 805 to the negative side in the X-axis direction, and is connected to the first hole 88-11P. The third hole 88-13P extends from the rear surface 802 to the positive side in the Y-axis direction, and is connected to the second hole 88-12P. The fourth hole 88-14P extends from the positive side in the Y-axis direction of the third hole 88-13P to the negative side in the Z-axis direction. The fifth hole 88-15P extends from the rear surface 802 to the positive side in the Y-axis direction, and is connected to the fourth hole 88-14P. The sixth hole 88-16P extends from an end on the positive side in the Y-axis direction of the fifth hole 88-15P to the positive side in the X-axis direction, the negative side in the Y-axis direction, and the negative side in the Z-axis direction, and is connected to the medium-diameter part of the shutoff valve accommodating hole 841P. The seventh hole 88-17 extends from the left side surface 806 to the positive side in the X-axis direction, is connected to the fifth hole 88-15P, and is connected to the master cylinder pressure sensor accommodating hole 851. The S system is symmetrical with the P system about the center in the X-axis direction of the housing 8 except that the seventh hole 88-17 is not included.

The second hole group 88-2y includes first holes 88-21 to seventh holes 88-27. First, description is given of the P system. The first hole 88-21P extends over a short distance from a bottom part of the shutoff valve accommodating holes 841 to the positive side in the Y-axis direction. The second hole 88-22P extends from the right side surface 805 to the negative side in the X-axis direction, and is connected to the first hole 88-21P. The third hole 88-23P extends from the top surface 803 to the negative side in the Z-axis direction, and is connected to the second hole 88-22P on the positive side in the X-axis direction. The fourth hole 88-24P extends from the right side surface 805 to the negative side in the X-axis direction, and is connected to an intermediate portion of the third hole 88-23P. The fifth holes 88-25a and 88-25d extend over short distances from the positive side in the X-axis direction of the fourth hole 88-24P to the positive side in the Y-axis direction, and are connected to bottom parts of the SOL/V IN accommodating holes 842a and 842d, respectively. The sixth hole 88-26P extends from an intermediate portion of the second hole 88-22P to the negative side in the Y-axis direction and the negative side in the Z-axis direction, and is connected to the medium-diameter part of the communication valve accommodating hole 843P. The seventh hole 88-27P extends from a bottom part of the wheel cylinder hydraulic pressure sensor accommodating hole 852P to the positive side in the Y-axis direction, and is connected to an intermediate portion of the second hole 88-22P. The S system is symmetrical with the P system about the center in the X-axis direction of the housing 8 except that the eighth hole 88-28 is included. The eighth hole 88-28 extends from the negative side in the X-axis direction of the bottom surface 804 to the positive side in the Z-axis direction, is connected to the medium-diameter part of the SS/V IN accommodating hole 847, and is connected to the medium-diameter part of the communication valve accommodating hole 843S.

The third hole group 88-3y includes a first hole 88-31 to a twelfth hole 88-312. The first hole 88-31 extends from the discharge port 821 of the cylinder accommodating hole 82A to the negative side in the Z-axis direction. The second hole 88-32 extends from an end of the first hole 88-31 to the negative side in the X-axis direction and the negative side in the Z-axis direction, and is connected to the discharge port 821 of the cylinder accommodating hole 82B. The third hole 88-33 extends from the discharge port 821 of the cylinder accommodating hole 82B to the positive side in the X-axis direction and the negative side in the Z-axis direction. The fourth hole 88-34 extends from an end of the third hole 88-33 to the positive side in the X-axis direction and the negative side in the Z-axis direction, and is connected to the discharge port 821 of the cylinder accommodating hole 82C. The fifth hole 88-35 extends from the discharge port 821 of the cylinder accommodating hole 82C to the positive side in the X-axis direction and the positive side in the Z-axis direction. The sixth hole 88-36 extends from an end of the fifth hole 88-35 to the positive side in the X-axis direction and the positive side in the Z-axis direction, and is connected to the discharge port 821 of the cylinder accommodating hole 82D. The seventh hole 88-37 extends from the discharge port 821 of the cylinder accommodating hole 82D to the negative side in the X-axis direction and the positive side in the Z-axis direction. The eighth hole 88-38 extends from an end of the seventh hole 88-37 to the positive side in the Z-axis direction, and is connected to the discharge port 821 of the cylinder accommodating hole 82E. The ninth hole 88-39 extends from a bottom part of the discharge pressure sensor accommodating hole 853 to the positive side in the Y-axis direction, is connected to the damper chamber 831, and is connected to the discharge port 821 of the cylinder accommodating hole 82C. The tenth hole 88-310 extends from a bottom part of the damper chamber 831 to the positive side in the Z-axis direction. The eleventh hole 88-311 extends from the right side surface 805 to the negative side in the X-axis direction, is connected to bottom parts of both of the communication valve accommodating holes 843, and is connected to an end of the tenth hole 88-310. The twelfth hole 88-312 (not shown) extends over a short distance from a bottom part of the pressure regulating valve accommodating hole 844 to the positive side in the Y-axis direction, and is connected to the eleventh hole 88-311.

The fourth hole group 88-4y includes a first hole 88-41 to a ninth hole 88-49. The first hole 88-41 extends from the left side surface 806 to the positive side in the X-axis direction, is connected to a bottom part of the reservoir chamber 830, and is connected to bottom parts of the SOL/V OUT accommodating holes 845. The second hole 88-42 extends from the bottom part of the reservoir chamber 830 to the positive side in the X-axis direction, the positive side in the Y-axis direction, and the negative side in the Z-axis direction, and is connected to the suction port 823 of the cylinder accommodating hole 82A. The third hole 88-43 extends from the bottom part of the reservoir chamber 830 to the positive side in the X-axis direction, the positive side in the Y-axis direction, and the negative side in the Z-axis direction, and is connected to the suction port 823 of the cylinder accommodating hole 82E. The fourth hole 88-44 extends from the left side surface 806 to the positive side in the X-axis direction, and is connected to the suction port 823 of the cylinder accommodating hole 82A. The fifth hole 88-45 extends from the right side surface 805 to the negative side in the X-axis direction, and is connected to the suction port 823 of the cylinder accommodating hole 82E. The sixth hole 88-46 extends from a bottom part of the liquid reservoir chamber 832 to the positive side in the Z-axis direction, is connected to the suction port 823 of the cylinder accommodating hole 82B, and is connected to an intermediate portion of the fourth hole 88-44. The seventh hole 88-47 extends from the bottom surface 804 to the positive side in the Z-axis direction, is connected to the suction port 823 of the cylinder accommodating hole 82D, and is connected to an intermediate portion of the fifth hole 88-45. The eighth hole 88-48 extends from the right side surface 805 to the negative side in the X-axis direction and the positive side in the Z-axis direction, is connected to the suction port 823 of the cylinder accommodating hole 82C, and is connected to an intermediate portion of the sixth hole 88-46 and an intermediate portion of the seventh hole 88-47. The ninth hole 88-49 extends from a bottom part of the SS/V OUT accommodating hole 848 to the positive side in the Y-axis direction, and is connected to an intermediate portion of the seventh hole 88-47.

The fifth hole group 88-5y includes a first hole 88-51 to a sixth hole 88-56. The first hole 88-51 extends from a bottom part of the back pressure port 874 to the negative side in the X-axis direction. The second hole 88-52 extends from an end of the first hole 88-51 to the negative side in the Z-axis direction. The third hole 88-53 extends from the rear surface 802 to the positive side in the Y-axis direction. The third hole 88-53 is connected to the second hole 88-52 in the course. The fourth hole 88-54 extends from the left surface 806 to the positive side in the X-axis direction. An end of the third hole 88-53 is connected to an intermediate portion of the fourth hole 88-54. The fifth hole 88-55 extends from an end of the fourth hole 88-54 to the negative side in the Y-axis direction over a short distance, and is connected to a bottom part of the SS/V IN accommodating hole 847. The sixth hole 88-56 extends from an intermediate portion of the first hole 88-51 to the negative side in the Y-axis direction and the negative side in the Z-axis direction over a short distance, and is connected to the medium-diameter part of the SS/V OUT accommodating hole 848. Each of the holes 880 extends from a bottom part of the wheel cylinder port 872 to the negative side in the Z-axis direction, is connected to the medium-diameter part of the SOL/V OUT accommodating hole 845, and is connected to the medium-diameter part of the SOL/V IN accommodating hole 842. The hole 881 extends from the cam accommodating hole 81 to the negative side in the X-axis direction and the negative side in the Z-axis direction, and is connected to the medium-diameter part 832m of the liquid reservoir chamber 832.

The first hole 88-11 to the sixth hole 88-16P of the first hole group 88-1y connect the master cylinder ports 871 and the shutoff valve accommodating holes 841 to each other, and function as a part of the supply oil passages 11. The first hole 88-21 to the fifth hole 88-25 of the second hole group 88-2y connect the shutoff valve accommodating holes 841 and the SOL/V IN accommodating holes 842 to each other, and function as a part of the supply oil passages 11. The sixth hole 88-26P connects the communication valve accommodating hole 843 and the second hole 88-22P to each other, and functions as a part of the discharge oil passage 13. The eighth hole 88-28 connects the SS/V IN accommodating hole 847 and the communication valve accommodating hole 843S to each other, and functions as a part of the first simulator oil passage 17. Each of the holes 880 connects the SOL/V IN accommodating hole 842 and the wheel cylinder port 872 to each other, and functions as a part of the supply oil passage 11. Moreover, each of the holes 880 connects the SOL/V IN accommodating hole 842 and the SOL/V OUT accommodating hole 845 to each other, and functions as a part of the pressure reducing oil passage 15. The first hole 88-31 to the eleventh hole 88-311 of the third hole group 88-3y connect the discharge ports 821 of the cylinder accommodating holes 82 and the communication valve accommodating holes 843 to each other, and function as a part of the discharge oil passages 13. The twelfth hole 88-312 connects the eleventh hole 88-311 and the pressure regulating valve accommodating hole 844 to each other, and functions as a part of the pressure regulating oil passage 14. The first hole 88-41 of the fourth hole group 88-4y connects the SOL/V OUT accommodating hole 845 and the reservoir chamber 830 to each other, and functions as a part of the pressure reducing oil passage 15. The second hole 88-42 to the eighth hole 88-48 connect the reservoir chamber 830 and the suction ports 823 of the cylinder accommodating holes 82 to each other, and function as the suction oil passage 12. The ninth hole 88-49 connects the SS/V OUT accommodating hole 848 and the seventh hole 88-47 to each other, and functions as the second simulator oil passage 18. The first hole 88-51 to the fifth hole 88-55 of the fifth hole group 88-5y connect the back pressure port 874 and the SS/V IN accommodating hole 847 to each other, and function as a part of the back pressure oil passage 16 and the first simulator oil passages 17. The sixth hole 88-56 connects the first hole 88-51 and the SS/V OUT accommodating hole 848 to each other, and functions as a part of the second simulator oil passage 18. The hole 881 connects the cam accommodating hole 81 and the liquid reservoir chamber 832 to each other, and serves as a drain oil passage.

A plurality of bolt holes 89x include bolt holes 891 to 895. The bolt hole 891 has a bottomed tubular shape, which has an axial center extending in the Y-axis direction, and is opened in the front surface 801. Three holes 891 are formed at positions approximately symmetrical about the axial center O of the cam accommodating hole 81. Distances from the axial center O to the respective holes 891 are approximately the same. One hole 891 is formed approximately at the center in the X-axis direction (position overlapping with the axial center O in the X-axis direction) and on the positive side in the Z-axis direction with respect to the axial center O in the front surface 801. This hole 891 is positioned between the master cylinder ports 871P and 871S in the X-axis direction, and overlaps with the reservoir chamber 830 as viewed from the Y-axis direction. Other two holes 891 are on both sides in the X-axis direction with respect to the axial center O, and on the negative side in the Z-axis direction with respect to the axial center O. The bolt hole 892 has a bottomed tubular shape, which has an axial center extending in the Y-axis direction, and is opened in the rear surface 802. A total of four holes 892 are formed at four corners of the rear surface 802, respectively. The bolt hole 893 has a bottomed tubular shape, which has an axial center extending in the Z-axis direction, and is opened in the top surface 803. One hole 893 is formed approximately at the center in the X-axis direction (position overlapping with the axial center O in the X-axis direction) on the positive side in the Y-axis direction in the top surface 803. The bolt hole 894 has a bottomed tubular shape, which has an axial center extending in the Y-axis direction, and is opened in the front surface 801. Two holes 894 are formed on the negative side in the Z-axis direction with respect to the axial center O and at both ends in the X-axis direction in the front surface 801. The holes 894 are positioned on an opposite side of the master cylinder port 871 with respect to the axial center O. The hole 894 on the negative side in the X-axis direction is approximately on the opposite side of the primary port 871P with respect to the axial center O. The hole 894 on the positive side in the X-axis direction is approximately on the opposite side of the secondary port 871S with respect to the axial center O. The axial centers of the holes 894 are arranged on the negative side in the Z-axis direction with respect to the axial centers of the bolt holes 891 on the negative side in the Z-axis direction, and on sides (outer sides) closer to the side surfaces 805 and 806 in the X-axis direction. The bolt hole 895 has a bottomed tubular shape, which has an axial center extending in the Z-axis direction, and two bolt holes 895 are provided, and are opened approximately at the center in the Y-axis direction, and on both ends in the X-axis direction on the bottom surface 804. An end on the positive side in the Z-axis direction of the hole 895 overlaps with the bolt hole 894 as viewed from the Y-axis direction.

The ECU 90 is configured to input detection values of the stroke sensor 94, the hydraulic pressure sensor 91, and the like, and information on the travel state from the vehicle side, and control the opening/closing operations of the electromagnetic valves 21 and the like and the number of revolutions (namely a discharge amount of the pump 3) of the motor 20 based on a built-in program, to thereby control the wheel cylinder hydraulic pressures) of the respective wheels FL to RR. With such control, the ECU 90 carries out various types of brake control (for example, antilock brake control of suppressing slip of wheels caused by the braking, boost control of decreasing a brake operation force of the driver, brake control for motion control for the vehicle, automatic brake control, for example, preceding vehicle following control, and regeneration cooperative brake control). The motion control for the vehicle includes stabilization control of vehicle behavior such as lateral slipping. The regeneration cooperative brake control controls the wheel cylinder hydraulic pressures so as to achieve a target deceleration (target braking forces) in cooperation with regenerative braking.

The ECU 90 includes a brake operation amount detection part 90a, a target wheel cylinder hydraulic pressure calculation part 90b, a stepping force braking generation part 90c, a boost control part 90d, and a control switching part 90e. The brake operation amount detection part 90a is configured to receive input of the detection value of the stroke sensor 94, to thereby detect a displacement amount (pedal stroke) of the brake pedal 100 as a brake operation amount. The target wheel cylinder hydraulic pressure calculation part 90b is configured to calculate target wheel cylinder hydraulic pressures. Specifically, the target wheel cylinder hydraulic pressure calculation part 90b is configured to calculate the target wheel cylinder hydraulic pressures for achieving a predetermined boost ratio, namely an ideal relationship between the pedal stroke and required brake hydraulic pressures of the driver (vehicle deceleration G required by the driver) based on the detected pedal stroke. Moreover, the target wheel cylinder hydraulic pressure calculation part 90b is configured to calculate the target wheel cylinder hydraulic pressures based on a relationship with a regenerative braking force during the regeneration cooperative brake control. For example, the target wheel cylinder hydraulic pressure calculation part 90b is configured to calculate such target wheel cylinder hydraulic pressures that a sum of a regenerative braking force input from a control unit of a regenerative braking device and a hydraulic pressure braking force corresponding to the target wheel cylinder hydraulic pressures satisfies the vehicle deceleration required by the driver. The target wheel cylinder hydraulic pressure calculation part 90b is configured to calculate the target wheel cylinder hydraulic pressures of the respective wheels FL to RR in order to achieve a desired vehicle motion state, for example, based on a detected vehicle motion state amount (for example, a lateral acceleration) during the motion control.

The stepping force braking generation part 90c is configured to set the pump 3 to a non-operation state, and control the shutoff valves 21 toward the open direction, control the SS/V IN 27 toward the closed direction, and control the SS/V OUT 28 toward the closed direction. In the state in which the shutoff valves 21 are controlled toward the open direction, the oil passage system (for example, the supply oil passages 11) configured to connect the hydraulic pressure chambers 50 of the master cylinder 5 and the wheel cylinders W/C to each other achieves stepping force braking (non-boost control) of generating the wheel cylinder hydraulic pressures through the master cylinder hydraulic pressure generated by the pedal stepping force. The SS/V OUT 28 is controlled toward the closed direction, and the stroke simulator 6 does not thus function. In other words, the operation of the piston 61 of the stroke simulator 6 is suppressed, and the inflow of the brake fluid from the hydraulic pressure chamber 50 (secondary chamber 50S) to the positive pressure chamber 601 is thus suppressed. As a result, the wheel cylinder hydraulic pressures can more efficiently be boosted. The S/V IN 27 may be controlled toward the closed direction.

In the state in which the SS/V IN 27 is controlled toward the closed direction, and the SS/V OUT 28 is controlled toward the open direction while the shutoff valves 21 are controlled toward the closed direction, a braking system (the suction oil passage 12, the discharge oil passage 13, and the like) configured to connect the reservoir 120 and the wheel cylinders W/C to each other functions as a so-called brake-by-wire system configured to generate the wheel cylinder hydraulic pressures through the hydraulic pressure generated by the pump 3, to thereby achieve the boost control, the regeneration cooperative control, and the like. The boost control part 90d is configured to operate the pump 3, control the shutoff valves 21 toward the closed direction, and control the communication valves 23 toward the open direction, to thereby bring the state of the second unit 1B into a state in which the wheel cylinder hydraulic pressures can be generated by the pump 3 during the brake operation by the driver. As a result, the boost control part 90d is configured to carry out the boost control of using the discharge pressure of the pump 3 as a hydraulic pressure source to generate the wheel cylinder hydraulic pressures higher than the master cylinder hydraulic pressure, to thereby generate the hydraulic pressure braking force that is not sufficiently generated by the brake operation force of the driver. Specifically, the boost control part 90d is configured to control the pressure regulating valve 24 while operating the pump 3 at a predetermined number of revolutions to adjust the brake fluid amount supplied from the pump 3 to the wheel cylinders W/C, to thereby achieve the target wheel cylinder hydraulic pressures. In other words, the braking device 1 is configured to operate the pump 3 of the second unit 1B in place of an engine negative pressure booster, to thereby provide a boost function of assisting the brake operation force. Moreover, the boost control part 90d is configured to control the SS/V N 27 toward the closed direction, and control the SS/V OUT 28 toward the open direction. With such control, the boost control part 90d causes the stroke simulator 6 to function. The control switching part 90e is configured to control the operation of the master cylinder 5, to thereby switch between the stepping force braking and the boost control based on the calculated target wheel cylinder hydraulic pressures. Specifically, when the start of the brake operation is detected by the brake operation amount detection part 90a, the control switching part 90e is configured to cause the stepping force braking generation part 90c to generate the wheel cylinder hydraulic pressures when the calculated target wheel cylinder hydraulic pressures are equal to or less than predetermined values (for example, values corresponding to the maximum value of the vehicle deceleration G generated during normal braking, which is not sudden braking). Meanwhile, when the target wheel cylinder hydraulic pressures calculated upon the brake stepping operation exceed the predetermined values, the control switching part 90e causes the boost control part 90d to generate the wheel cylinder hydraulic pressures.

Moreover, the ECU 90 includes a sudden brake operation state determination part 90f and a second stepping force braking generation part 90g. The sudden brake operation state determination part 90f is configured to detect a brake operation state based on input, for example, from the brake operation amount detection part 90a and the like, to thereby determine (decide) whether or not the brake operation state is a predetermined sudden brake operation state. For example, the sudden brake operation state determination part 90f is configured to determine whether or not a change amount of the pedal stroke per unit time exceeds a predetermined threshold amount. The control switching part 90e is configured to switch the control so that the wheel cylinder hydraulic pressures are generated by the second stepping force braking generation part 90g when the brake operation state is determined to be the sudden brake operation state. The second stepping force braking generation part 90g is configured to operate the pump 3, and control the shutoff valves 21 toward the closed direction, control the SS/V IN 27 toward the open direction, and control the SS/V OUT 28 toward the closed direction. With such control, there is achieved second stepping force braking of using the brake fluid having flowed out from the back pressure chamber 602 of the stroke simulator 6 to generate the wheel cylinder hydraulic pressures until the pump 3 can generate sufficiently high wheel cylinder hydraulic pressures. The shutoff valves 21 may be controlled toward the open direction. Moreover, the SS/V IN 27 may be controlled toward the closed direction, and, in this case, the brake fluid from the back pressure chamber 602 is supplied to the wheel cylinder W/C side via the check valve 270 (in the valve open state because the pressure on the wheel cylinder W/C side is still lower than that on the back pressure chamber 602 side). In this embodiment, the brake fluid can efficiently be supplied from the back pressure chamber 602 side to the wheel cylinder W/C side by controlling the SS/V IN 27 toward the open direction. Then, when the brake operation state is no longer determined to be the sudden brake operation state, and/or a predetermined condition indicating that a discharge performance of the pump 3 has become sufficient is satisfied, the control switching part 90e switches the control so as to cause the boost control part 90d to generate the wheel cylinder hydraulic pressures. In other words, the boost control part 90d controls the SS/V IN 27 toward the closed direction, and controls the SS/V OUT 28 toward the open direction. With such control, the boost control part 90d causes the stroke simulator 6 to function. The control may be switched to the regeneration cooperative brake control after the second stepping force braking.

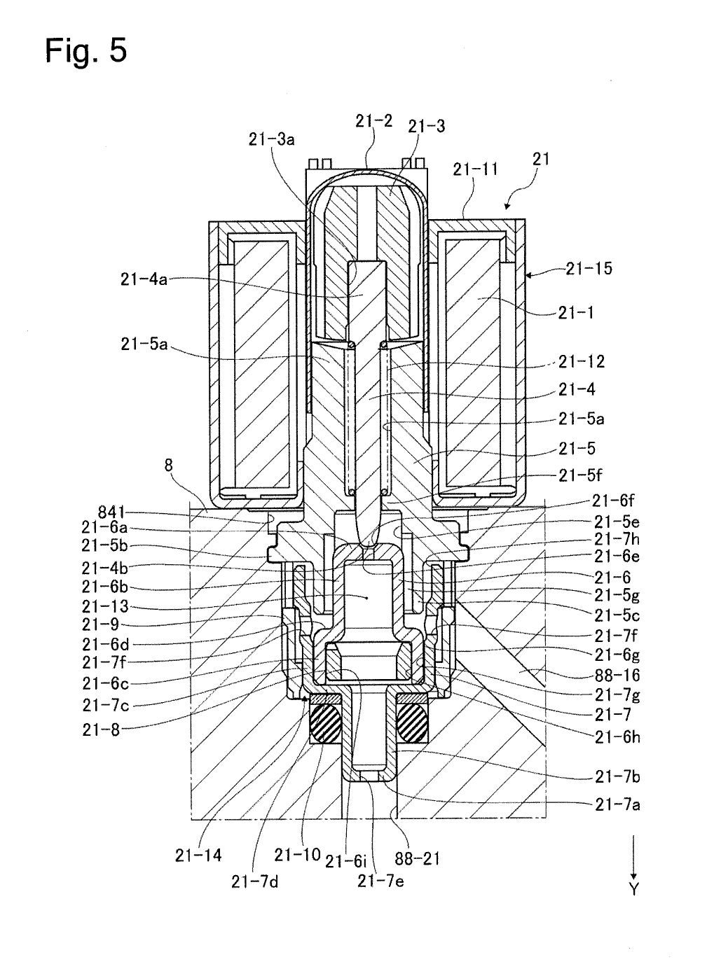

Referring to FIG. 5 to FIG. 13, a description is now given of configurations of the shutoff valve 21, the SOL/V IN 22, the communication valve 23, the pressure regulating valve 24, the SS/V IN 27, and the SS/V OUT 28.

In general, a normally-open electromagnetic valve and a normally-closed electromagnetic valve used for a hydraulic pressure control device such as a brake device are separately designed due to differences in structure, and are thus different in length of a mounting portion mounted to a housing. In this embodiment, focus is given on a point of being capable of improving the degree of freedom in layout of the oil passages inside the housing, and of preventing the degradation of the vehicle mountability, by finding out a method of setting equal lengths to the mounting portions.

[Shutoff Valve and Pressure Regulating Valve]

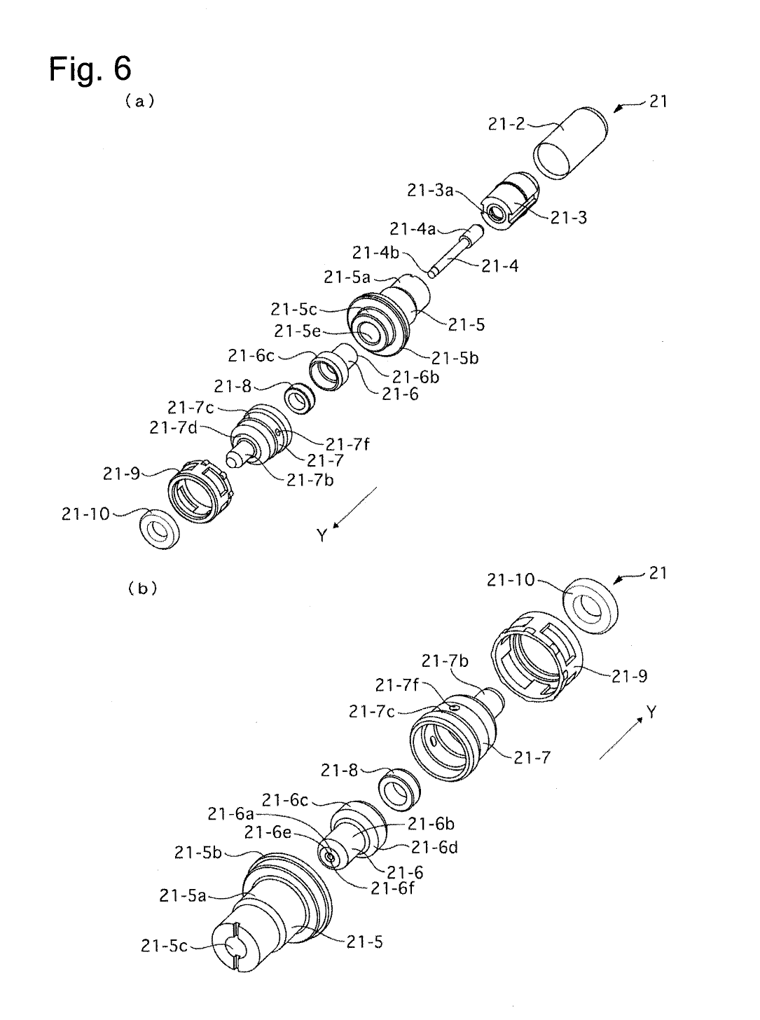

Structures of the shutoff valve 21 and the pressure regulating valve 24 are the same, and a description is given only of the shutoff valve 21. FIG. 5 is a longitudinal sectional view of the shutoff valve 21. FIG. 6 are exploded perspective views of the shutoff valve 21. FIG. 6(a) is a view as viewed from the positive side in the Y-axis direction, and FIG. 6(b) is a view as viewed from the negative side in the Y-axis direction.

The shutoff valve 21 includes a coil 21-1, a cylinder 21-2, an armature 21-3, a plunger (21-4, a valve body 21-5, a seat member 21-6, a body member 21-7, a first filter member 21-8, a second filter member 21-9, and a seal member 21-10. An electromagnetic drive part 21-15 is formed of the coil 21-1, the cylinder 21-2, the armature 21-3, and the valve body 21-5.

The coil 21-1 is configured to generate an electromagnetic force through a current supply. The coil 21-1 is accommodated in a yoke 21-11 made of a magnetic material.

The cylinder 21-2 is made of a non-magnetic material formed into a tubular shape. An end on the positive side in the Y-axis direction of the cylinder 21-2 is opened, and an end on the negative side in the Y-axis direction is closed by a semispherical bottom portion. The end on the positive side in the Y-axis direction of the cylinder 21-2 is welded to a first tubular part 21-5a of the valve body 21-5 described later.

The armature 21-3 is made of a magnetic material, and is provided so as to be movable in the Y-axis direction inside the cylinder 21-2. A recessed part 21-3a into which the plunger 21-4 is press-fitted is formed at a center of an end on the positive side in the Y-axis direction of the armature 21-3. The armature 21-3 is moved toward the positive side in the Y-axis direction by the electromagnetic force generated by the coil 21-1 when a current is supplied to the coil 21-1.

The plunger 21-4 is made of a non-magnetic material such as resin formed into a rod shape. The plunge 21-4 is arranged along the Y-axis direction inside the cylinder 21-2. A large-diameter part 21-4a lager in diameter than an end on the positive side in the Y-axis direction of the plunger 21-4 is formed on the negative side in the Y-axis direction of the plunger 21-4. A tip part 21-4b, which is an end on the positive side in the Y-axis direction of the plunger 21-4, is formed into a semispherical shape. The large-diameter part 21-4a is press-fitted into the recessed part 21-3a of the armature 21-3. The plunger 21-4 is driven integrally with the armature 21-3.

The valve body 21-5 is made of a magnetic material formed into a tubular shape. The valve body 21-5 includes a first tubular part 21-5a provided on the negative side in the Y-axis direction, and configured to function as a magnetic path formation member, a crimped part 21-5b increased in diameter, and fixed to the housing 8 through crimping, and a second tubular part 21-5c provided on the positive side in the Y-axis direction, and inserted into the shutoff valve accommodating hole 841. A first accommodating hole (insertion hole) 21-5d is formed in an inner periphery of the first tubular part 21-5a. A second accommodating hole 21-5e larger in diameter than the first accommodating hole 21-5d is formed in an inner periphery of the second tubular part 21-5c. A lock part 21-5f protruding inward in the radial direction is formed on an end on the positive side in the Y-axis direction of the first accommodating hole 21-5d. A coil spring 21-12 is provided in a compressed state between the lock part 21-5f and the large-diameter part 21-4a of the plunger 21-4. The coil spring 21-12 is configured to urge the plunger 21-4 toward the negative side in the Y-axis direction. A plurality of axial oil passages 21-5g are formed in the second accommodating hole 21-5e.

The seat member 21-6 is arranged in the shutoff valve accommodating hole 841. The seat member 21-6 includes a bottom part 21-6a at an end on the negative side in the Y-axis direction, and is formed into a tubular shape having an opening 21-6i opened at an end on the positive side in the Y-axis direction. The seat member 21-6 includes a small-diameter part 21-6b, a large-diameter part 21-6c, and a first step part 21-6d. The small-diameter part 21-6b includes a bottom part 21-6a, is provided on the negative side in the Y-axis direction, and is press-fitted into and fixed to the second accommodating hole 21-5e of the valve body 21-5. A first communication hole 21-6e is formed in the bottom part 21-6a. A valve seat 21-6f against which the tip part 21-4b of the plunger 21-4 abuts is formed around the first communication hole 21-6e. The large-diameter part 21-6c is provided on the positive side in the Y-axis direction with respect to the small-diameter part 21-6b, and is formed so as to be larger in diameter than the small-diameter part 21-6b. The first step part 21-6d extends in a direction approximately orthogonal to the Y-axis direction, and connects the small-diameter part 21-6b and the large-diameter part 21-6c to each other.

The body member 21-7 is arranged in the shutoff valve accommodating hole 841, and is provided at a position outside the seat member 21-6. The body member 21-7 includes a bottom part 21-7a at an end on the positive side in the Y-axis direction, and is formed into a tubular shape having an opening 21-7h opened at an end on the positive side in the Y-axis direction. The body member 21-7 includes a small-diameter part 21-7b, a large-diameter part 21-7c, and a second step part 21-7d. The small-diameter part 21-7b includes a bottom part 21-7a, and is provided on the positive side in the Y-axis direction. A second communication hole 21-7e is formed in the bottom part 21-7a. The second communication hole 21-7e is connected to the first hole 88-21. The large-diameter part 21-7c is provided on the negative side in the Y-axis direction with respect to the small-diameter part 21-7b, and is formed so as to be larger in diameter than the small-diameter part 21-7b. The large-diameter part 21-6c of the seat member 21-6 is fitted to the large-diameter part 21-7c. An inner abutment surface 21-7g that abuts against an outer peripheral surface 21-6g of the large-diameter part 21-6c of the seat member 21-6a is provided on an inner peripheral surface of the large-diameter part 21-7c. A plurality of circulation holes 21-7f are formed in the large-diameter part 21-7c on the negative side in the Y-axis direction with respect to the inner abutment surface 21-7g. The circulation holes 21-7f are connected to the sixth hole 88-16. The second step part 21-7d extends in a direction approximately orthogonal to the Y-axis direction, and connects the small-diameter part 21-7b and the large-diameter part 21-7c to each other. An internal space surrounded by the seat member 21-6 and the body member 21-7 is a flow passage (internal oil passage) 21-13 through which the brake fluid flows. A valve part 21-14 is formed of the seat member 21-6 and the body member 21-7.

The first filter member 21-8 is provided in the flow passage 21-13. The first filter member 21-8 is configured to filter the brake fluid flowing from the second communication hole 21-7e into the first communication hole 21-6e, to thereby prevent contamination and the like in the brake fluid from being transmitted to the plunger 21-4 and the valve seat 21-6f. The first filter member 21-8 engages with the first step part 21-6d of the seat member 21-6 and the second step part 21-7d of the body member 21-7 so that a position in the Y-axis direction is maintained. The first filter member 21-8 is provided so as to face an inner peripheral surface 21-6h of the large-diameter part 21-6c of the seat member 21-6. A gap smaller than coarseness of a mesh part 21-8a described later is provided between the inner peripheral surface 21-6h of the seat member 21-6 and the outer peripheral surface 21-8c of the first filter member 21-8.

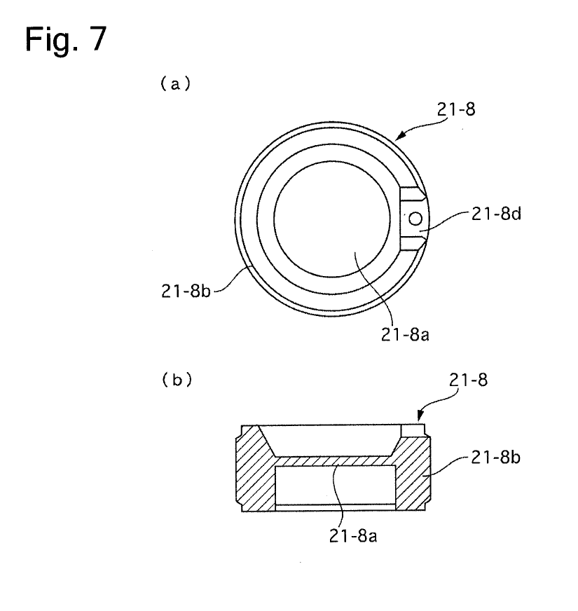

FIG. 7 are views for illustrating a shape of the first filter member 21-8. FIG. 7(a) is a plan view, and FIG. 7(b) is a side sectional view. The first filter member 21-8 is injection-molded of a resin material, and includes the mesh part 21-8a and a frame body 21-8b. The mesh part 21-8a is formed into a net form having a predetermined coarseness. The frame body 21-8b is formed into an annular shape, and is provided on an outer periphery of the mesh part 21-8a. A recessed part 21-8d is formed at a position corresponding to a gate in one end surface of the frame body 21-8b. A height of a remaining portion of the gate can be prevented from exceeding the one end surface of the frame body 21-8b by providing the recessed part 21-8d. The first filter member 21-8 is arranged in a state in which the recessed part 21-8d faces the negative side in the Y-axis direction.

A second filter member 21-9 is injection-molded of a resin material. The second filter member 21-9 is arranged at a position outside the body member 21-7, and overlaps the first filter member 21-8 in the Y-axis direction. The second filter member 21-9 is configured to filter the brake fluid flowing from the sixth hole 88-16 into the circulation holes 21-7f, to thereby prevent contamination and the like in the brake fluid from being transmitted to the plunger 21-4 and the valve seat 21-6f.

The seal member 21-10 is an O ring, and is mounted on an outer periphery of the small-diameter part 21-7b of the body member 21-7, thereby sealing a gap between an outer peripheral surface of the small-diameter part 21-7b and an inner peripheral surface of the shutoff valve accommodating hole 841.

A description is now given of an operation of the shutoff valve 21.

When the current is not supplied to the coil 21-1, the armature 21-3 and the plunger 21-4 are urged by an urging force of the coil spring 21-12 toward the negative side in the Y-axis direction, and the tip part 21-4b of the plunger 21-4 is thus separated from the valve seat 21-6f. Therefore, the sixth hole 88-16 and the first hole 88-21 communicate with each other via the circulation holes 21-7f, the axial oil passages 21-5g, the first communication hole 21-6e, and the second communication hole 21-7e.

When a predetermined current is supplied to the coil 21-1, a magnetic path is formed in the yoke 21-11, the armature 21-3, and the first tubular part 21-5a, and an attraction force is generated between the armature 21-3 and the first tubular part 21-5a. The armature 21-3 and the plunger 21-4 move toward the positive side in the Y-axis direction by the attraction force, and when the tip part 21-4b of the plunger 21-4 abuts against the valve seat 21-6f, the sixth hole 88-16 and the first hole 88-21 are shut off from each other. Moreover, a gap (flow passage cross sectional area) between the tip part 21-4b and the valve seat 21-6f can be controlled by controlling supplied power to the coil 21-1 through PWM control, to proportionally control the attraction force, to thereby achieve a desired flow rate (hydraulic pressure).

In the following description, reference numeral of each component of the pressure regulating valve 24 is obtained by replacing 21 of the reference numeral for the same component of the shutoff valve 21 with 24.

[SOL/V IN]

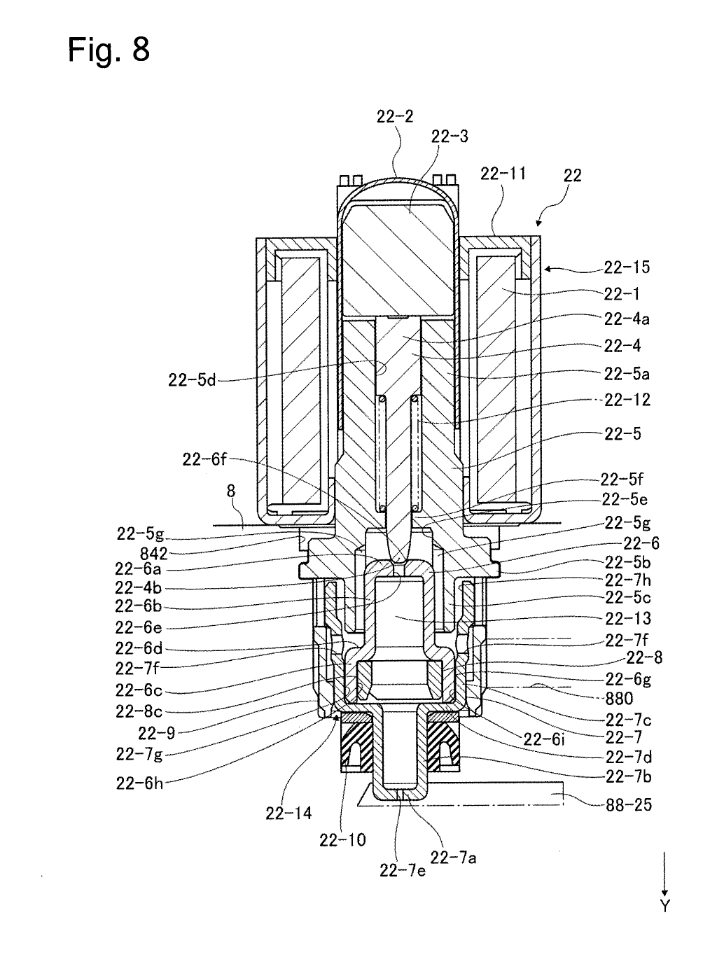

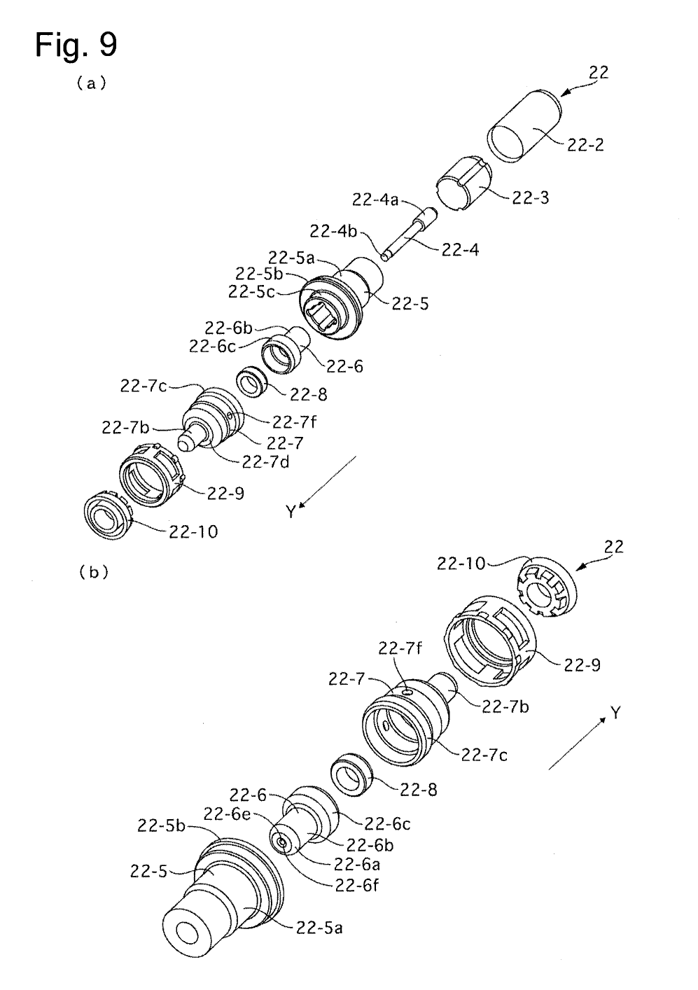

FIG. 8 is a longitudinal sectional view of the SOL/V IN 22. FIG. 9 are exploded perspective views of the SOL/V IN 22. FIG. 9(a) is a view as viewed from the positive side in the Y-axis direction, and FIG. 9(b) is a view as viewed from the negative side in the Y-axis direction.

The SOL/V IN 22 includes a coil 22-1, a cylinder 22-2, an armature 22-3, a plunger 22-4, a valve body 22-5, a seat member 22-6, a body member 22-7, a first filter member 22-8, a second filter member 22-9, and a seal member 22-10. An electromagnetic drive part 22-15 is formed of the coil 22-1, the cylinder 22-2, the armature 22-3, and the valve body 22-5.

The coil 22-1 is configured to generate an electromagnetic force through a current supply. The coil 22-1 is accommodated in a yoke 22-11 made of a magnetic material.

The cylinder 22-2 is made of a non-magnetic material formed into a tubular shape. An end on the positive side in the Y-axis direction of the cylinder 22-2 is opened, and an end on the negative side in the Y-axis direction is closed by a semispherical bottom part. The end on the positive side in the Y-axis direction of the cylinder 22-2 is welded to a first tubular part 22-5a of the valve body 22-5 described later.

The armature 22-3 is made of a magnetic material, and is provided so as to be movable in the Y-axis direction inside the cylinder 22-2. The armature 22-3 is moved toward the positive side in the Y-axis direction by the electromagnetic force generated by the coil 22-1 when a current is supplied to the coil 22-1.

The plunger 22-4 is made of a non-magnetic material such as resin formed into a rod shape. The plunge 22-4 is arranged along the Y-axis direction inside the cylinder 22-2. A large-diameter part 22-4a larger in diameter than an end on the positive side in the Y-axis direction of the plunger 22-4 is formed on the negative side in the Y-axis direction of the plunger 22-4. A tip part 22-4b, which is an end on the positive side in the Y-axis direction of the plunger 22-4, is formed into a semispherical shape. An end on the negative side in the Y-axis direction of the large-diameter part 22-4a abuts against an end on the positive side in the Y-axis direction of the armature 22-3. The plunger 22-4 is driven integrally with the armature 22-3.

The valve body 22-5 is made of a magnetic material formed into a tubular shape. The valve body 22-5 includes a first tubular part 22-5a provided on the negative side in the Y-axis direction, and configured to function as a magnetic path formation member, a crimped part 22-5b increased in diameter, and fixed to the housing 8 through crimping, and a second tubular part 22-5c provided on the positive side in the Y-axis direction, and inserted into an SOL/V IN accommodating hole 842. A first accommodating hole (insertion hole) 22-5d is formed in an inner periphery of the first tubular part 22-5a. A second accommodating hole 22-5e larger in diameter than the first accommodating hole 22-5d is formed in an inner periphery of the second tubular part 22-5c. A lock part 22-5f protruding inward in the radial direction is formed at an end on the positive side in the Y-axis direction of the first accommodating hole 22-5d. A coil spring 22-12 is provided in a compressed state between the lock part 22-5f and the large-diameter part 22-4a of the plunger 22-4. The coil spring 22-12 is configured to urge the plunger 22-4 toward the negative side in the Y-axis direction. A plurality of axial oil passages 22-5g are formed in the second accommodating hole 22-5e.

The seat member 22-6 is arranged in the SOL/V IN accommodating hole 842. The seat member 22-6 includes a bottom part 22-6a at an end on the negative side in the Y-axis direction, and is formed into a tubular shape having an opening 22-6i opened at an end on the positive side in the Y-axis direction. The seat member 22-6 includes a bottom part 22-6a at an end on the negative side in the Y-axis direction, and is formed into a tubular shape opened at an end on the positive side in the Y-axis direction. The seat member 22-6 includes a small-diameter part 22-6b, a large-diameter part 22-6c, and a first step part 22-6d. The small-diameter part 22-6b includes a bottom part 22-6a, is provided on the negative side in the Y-axis direction, and is press-fitted into and fixed to the second accommodating hole 22-5e of the valve body 22-5. A first communication hole 22-6e is formed in the bottom part 22-6a. A valve seat 22-6f against which the tip part 22-4b of the plunger 22-4 abuts is formed around the first communication hole 22-6e. The large-diameter part 22-6c is provided on the positive side in the Y-axis direction with respect to the small-diameter part 22-6b, and is formed so as to be larger in diameter than the small-diameter part 22-6b. The first step part 22-6d extends in a direction approximately orthogonal to the Y-axis direction, and connects the small-diameter part 22-6b and the large-diameter part 22-6c to each other.

The body member 22-7 is arranged in the SOL/V IN accommodating hole 842, and is provided at a position outside the seat member 22-6. The body member 22-7 includes a bottom part 22-7a at an end on the positive side in the Y-axis direction, and is formed into a tubular shape having an opening 22-7h opened at an end on the positive side in the Y-axis direction. The body member 22-7 includes a small-diameter part 22-7b, a large-diameter part 22-7c, and a second step part 22-7d. The small-diameter part 22-7b includes a bottom part 22-7a, and is provided on the positive side in the Y-axis direction. A second communication hole 22-7e is formed in the bottom part 22-7a. The second communication hole 22-7e is connected to the fifth hole 88-25. The large-diameter part 22-7c is provided on the negative side in the Y-axis direction with respect to the small-diameter part 22-7b, and is formed so as to be larger in diameter than the small-diameter part 22-7b. The large-diameter part 22-6c of the seat member 22-6 is fitted to the large-diameter part 22-7c. An inner abutment surface 22-7g that abuts against an outer peripheral surface 22-6g of the large-diameter part 22-6c of the seat member 22-6a is provided on an inner peripheral surface of the large-diameter part 22-7c. A plurality of circulation holes 22-7f are formed in the large-diameter part 22-7c on the negative side in the Y-axis direction with respect to the inner abutment surface 22-7g. The circulation holes 22-7f are connected to the oil passage hole 880. The second step part 22-7d extends in a direction approximately orthogonal to the Y-axis direction, and connects the small-diameter part 22-7b and the large-diameter part 22-7c to each other. An internal space surrounded by the seat member 22-6 and the body member 22-7 is a flow passage (internal oil passage) 22-13 through which the brake fluid flows. A valve part 22-14 is formed of the seat member 22-6 and the body member 22-7.

The first filter member 22-8 is provided in the flow passage 22-13. The first filter member 22-8 is configured to filter the brake fluid flowing from the second communication hole 22-7e into the first communication hole 22-6e, to thereby prevent contamination and the like in the brake fluid from being transmitted to the plunger 22-4 and the valve seat 22-6f. The first filter member 22-8 engages with the first step part 22-6d of the seat member 22-6 and the second step part 22-7d of the body member 22-7, to thereby maintain a position in the Y axis-direction. The first filter member 22-8 is provided so as to face an inner peripheral surface 22-6h of the large-diameter part 22-6c of the seat member 22-6. A gap smaller than coarseness of a mesh part 22-8a described later is provided between the inner peripheral surface 22-6h of the seat member 22-6 and the outer peripheral surface 22-8c of the first filter member 22-8. The shape of the first filter member 22-8 is the same as that of the first filter member 21-8 illustrated in FIG. 7, and a description thereof is therefore omitted. The first filter 22-8 is arranged in a state in which a recessed portion faces the positive side in the Y axis-direction.

A second filter member 22-9 is injection-molded of a resin material. The second filter member 22-9 is arranged at a position outside the body member 22-7, and overlaps the first filter member 22-8 in the Y-axis direction. The second filter member 22-9 is configured to filter the brake fluid flowing from the oil passage hole 880 into the circulation holes 22-7f, to thereby prevent contamination and the like in the brake fluid from being transmitted to the plunger 22-4 and the valve seat 22-6f.

The seal member 22-10 is a cup seal, and is mounted on an outer periphery of the small-diameter part 22-7b of the body member 22-7. The seal member 22-10 is configured to function as the check valve 220 by sealing a leak of the brake fluid from the fifth hole 88-25 to the oil passage hole 880 when (hydraulic pressure in fifth hole 88-25>hydraulic pressure in oil passage hole 880), and permitting a flow of the brake fluid from the oil passage hole 880 to the fifth hole 88-25 when (hydraulic pressure in fifth hole 88-25<hydraulic pressure in oil passage hole 880).

A description is now given of an operation of the SOL/V IN 22.

When the current is not supplied to the coil 22-1, the armature 22-3 and the plunger 22-4 are urged by an urging force of the coil spring 22-12 toward the negative side in the Y-axis direction, and the tip part 22-4b of the plunger 22-4 is thus separated from the valve seat 22-6f. Therefore, the fifth hole 88-25 and the oil passage hole 880 communicate with each other via the circulation holes 22-7f, the axial oil passages 22-5g, the first communication hole 22-6e, and the second communication hole 22-7e.

When a predetermined current is supplied to the coil 22-1, a magnetic path is formed in the yoke 22-11, the armature 22-3, and the first tubular part 22-5a, and an attraction force is generated between the armature 22-3 and the first tubular part 22-5a. The armature 22-3 and the plunger 22-4 move toward the positive side in the Y-axis direction through the attraction force, and when the tip part 22-4b of the plunger 22-4 abuts against the valve seat 22-6f, the fifth oil passage 88-25 and the oil passage hole 880 are shut off from each other. Moreover, a gap (flow passage cross sectional area) between the tip part 22-4b and the valve seat 22-6f can be controlled by controlling supplied power to the coil 22-1 through PWM control to proportionally control the attraction force, to thereby achieve a desired flow rate (hydraulic pressure).

[Communication Valve]

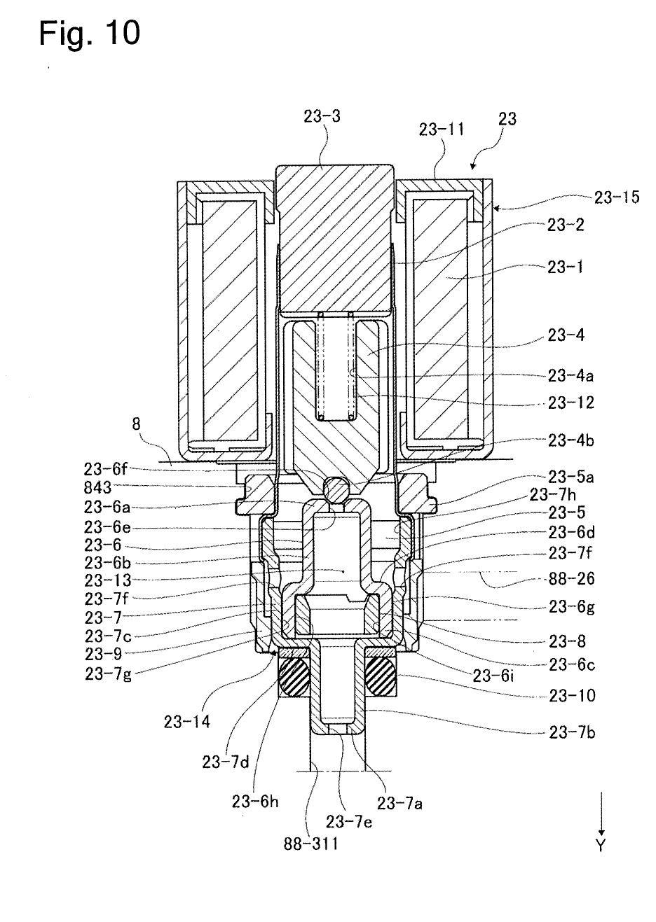

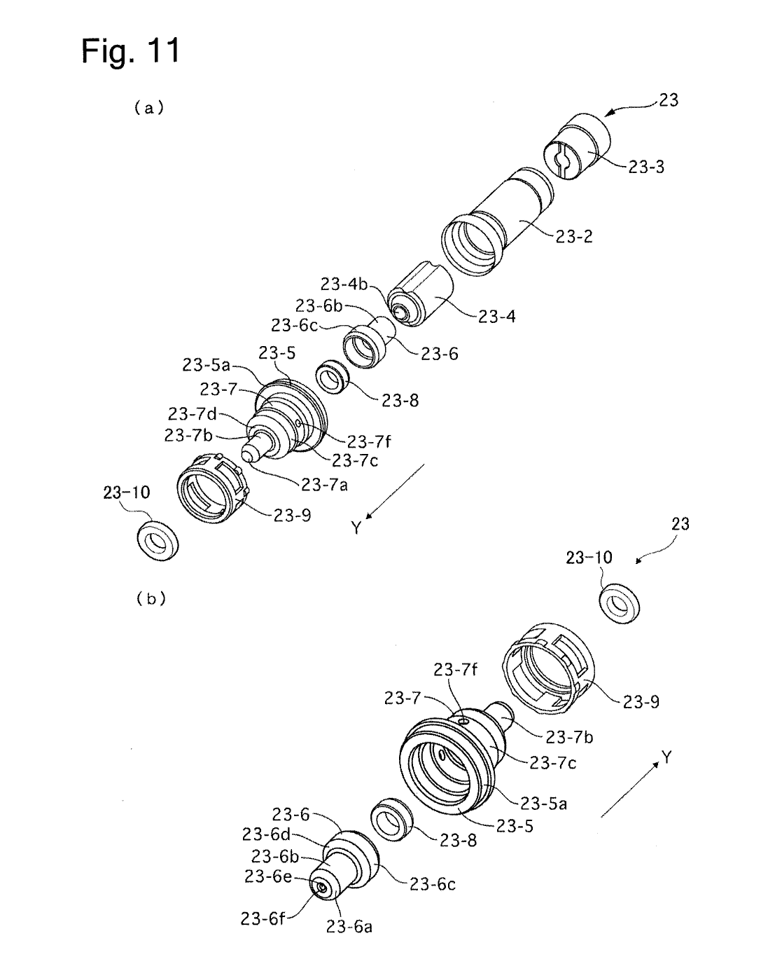

FIG. 10 is a longitudinal sectional view of the communication valve 23. FIG. 11 are exploded perspective views of the communication valve 23. FIG. 11(a) is a view as viewed from the positive side in the Y-axis direction, and FIG. 11(b) is a view as viewed from the negative side in the Y-axis direction.

The communication valve 23 includes a coil 23-1, a cylinder 23-2, a body center 23-3, an armature 23-4, a flange ring 23-5, a seat member 23-6, a body member 23-7, a first filter member 23-8, a second filter member 23-9, and a seal member 23-10. An electromagnetic drive part 23-15 is formed of the coil 23-1, the cylinder 23-2, and the armature 23-4.

The coil 23-1 is configured to generate an electromagnetic force through a current supply. The coil 23-1 is accommodated in a yoke 23-11 made of a magnetic material.

The cylinder 23-2 is made of a non-magnetic material formed into a tubular shape opened at both ends.

The body center 23-3 is made of a magnetic material. An end on the positive side in the Y-axis direction of the body center 23-3 is welded to an end on the negative side in the Y-axis direction of the cylinder 23-2. The body center 23-3 is configured to attract the armature 23-4 by the electromagnetic force generated by the coil 23-1 when the current is supplied to the coil 23-1.

The armature 23-4 is made of a magnetic material. The armature 23-4 is arranged along the Y-axis direction inside the cylinder 23-2. A recessed part 23-4a extending toward the positive side in the Y-axis direction is formed at an end on the negative side in the Y-axis direction of the armature 23-4. A coil spring 23-12 is provided in a compressed state between a bottom portion of the recessed part 23-4a and the body center 23-3. The coil spring 23-12 is configured to urge the armature 23-4 toward the positive side in the Y-axis direction. When a current is not supplied to the coil 23-1, a predetermined gap is provided between an end on the positive side in the Y-axis direction of the cylinder 23-2 and an end on the negative side in the Y-axis direction of the armature 23-4. A spherical valve body 23-4b is fixed to an end on the positive side in the Y-axis direction of the armature 23-4.

The flange ring 23-5 is made of a magnetic material formed into a tubular shape opened at both ends, and is arranged in the communication valve accommodating hole 843. The flange ring 23-5 includes a crimped part 23-5a increased in diameter, and fixed to the housing 8 through crimping.

The seat member 23-6 is arranged in the communication valve accommodating hole 843. The seat member 23-6 includes a bottom part 23-6a at an end on the negative side in the Y-axis direction, and is formed into a tubular shape having an opening 23-6i opened at an end on the positive side in the Y-axis direction. The seat member 23-6 includes a small-diameter part 23-6b, a large-diameter part 23-6c, and a first step part 23-6d. The small-diameter part 23-6b includes a bottom part 23-6a, and is provided on the negative side in the Y-axis direction. A first communication hole 23-6e is formed in the bottom part 23-6a. A valve seat 23-6f against which the tip part 23-4b of the armature 23-4 abuts is formed around the first communication hole 23-6e. The large-diameter part 23-6c is provided on the positive side in the Y-axis direction with respect to the small-diameter part 23-6b, and is formed so as to be larger in diameter than the small-diameter part 23-6b. The first step part 23-6d extends in a direction approximately orthogonal to the Y-axis direction, and connects the small-diameter part 23-6b and the large-diameter part 23-6c to each other.

The body member 23-7 is arranged in the communication valve accommodating hole 843, and is provided at a position outside the seat member 23-6. The body member 23-7 includes a bottom part 23-7a at an end on the positive side in the Y-axis direction, and is formed into a tubular shape having an opening 23-7h opened at an end on the positive side in the Y-axis direction. The body member 23-7 includes a small-diameter part 23-7b, a large-diameter part 23-7c, and a second step part 23-7d. The small-diameter part 23-7b includes a bottom part 23-7a, and is provided on the positive side in the Y-axis direction. A second communication hole 23-7e is formed in the bottom part 23-7a. The second communication hole 23-7e is connected to the eleventh hole 88-311. The large-diameter part 23-7c is provided on the negative side in the Y-axis direction with respect to the small-diameter part 23-7b, and is formed so as to be larger in diameter than the small-diameter part 23-7b. The large-diameter part 23-6c of the seat member 23-6 is fitted to the large-diameter part 23-7c. The large-diameter part 23-7c is inserted in an inner periphery of an end on the positive side in the Y-axis direction of the cylinder 23-2. A tip end of the large-diameter part 23-7c is inserted to a position of abutment against a side surface on the positive side in the Y-axis direction of the crimped part 23-5a via the cylinder 23-2. The large-diameter part 23-7c is fixed by crimping an end on the positive side in the Y-axis direction of the cylinder 23-2 along an outer peripheral surface of the large-diameter part 23-7c. An inner abutment surface 23-7g that abuts against an outer peripheral surface 23-6g of the large-diameter part 23-6c of the seat member 23-6a is provided on an inner peripheral surface of the large-diameter part 23-7c. A plurality of circulation holes 23-7f are formed in the large-diameter part 23-7c on the negative side in the Y-axis direction with respect to the inner abutment surface 23-7g. The circulation holes 23-7f are connected to the sixth hole 88-26. The second step part 23-7d extends in a direction approximately orthogonal to the Y-axis direction, and connects the small-diameter part 23-7b and the large-diameter part 23-7c to each other. An internal space surrounded by the seat member 23-6 and the body member 23-7 is a flow passage (internal oil passage) 23-13 through which the brake fluid flows. A valve part 23-14 is formed of the seat member 23-6 and the body member 23-7.

The first filter member 23-8 is provided in the flow passage 23-13. The first filter member 23-8 is configured to filter the brake fluid flowing from the second communication hole 23-7e into the first communication hole 23-6e, to thereby prevent contamination and the like in the brake fluid from being transmitted to the armature 23-4 and the valve seat 23-6f. The first filter member 23-8 engages with the first step part 23-6d of the seat member 23-6 and the second step part 23-7d of the body member 23-7, to thereby maintain a position in the Y axis-direction. The first filter member 23-8 is provided so as to face an inner peripheral surface 23-6h of the large-diameter part 23-6c of the seat member 23-6. A gap smaller than coarseness of a mesh part 23-8a described later is provided between the inner peripheral surface 23-6h of the seat member 23-6 and the outer peripheral surface 23-8c of the first filter member 23-8. The shape of the first filter member 23-8 is the same as that of the first filter member 21-8 illustrated in FIG. 7, and a description thereof is therefore omitted. The first filter 23-8 is arranged in a state in which a recessed portion faces the negative side in the Y axis-direction.

A second filter member 23-9 is injection-molded of a resin material. The second filter member 23-9 is arranged at a position outside the body member 23-7, and overlaps the first filter member 23-8 in the Y-axis direction. The second filter member 23-9 is configured to filter the brake fluid flowing from the sixth hole 88-26 into the circulation holes 23-7f, to thereby prevent contamination and the like in the brake fluid from being transmitted to the armature 23-4 and the valve seat 23-6f.

The seal member 23-10 is an O ring, and is mounted on an outer periphery of the small-diameter part 23-7b of the body member 23-7, to thereby seal a gap between an outer peripheral surface of the small-diameter part 23-7b and an inner peripheral surface of the communication valve accommodating hole 843.

A description is now given of an operation of the communication valve 23.

When the current is not supplied to the coil 23-1, the armature 23-4 is urged by an urging force of the coil spring 23-12 toward the positive side in the Y-axis direction, and the tip part 23-4b of the armature 23-4 thus abuts against the valve seat 23-6f. Therefore, the sixth hole 88-26 and the eleventh hole 88-311 are shut off from each other.

When a predetermined current is supplied to the coil 23-1, a magnetic path is formed in the yoke 23-11, the body center 23-3, and the armature 23-4, and an attraction force is generated between the body center 23-3 and the armature 23-4. The armature 23-4 moves toward the negative side in the Y-axis direction by the attraction force, and when the tip part 23-4b of the armature 23-4 separates from the valve seat 23-6f, the sixth hole 88-26 and the eleventh hole 88-311 communicate with each other via the circulation holes 23-7f, the axial oil passage 23-5g, the first communication hole 23-6e, and the second communication hole 23-7e.

[SS/V IN and SS/V OUT]

Structures of the SS/V IN 27 and the SS/V OUT 28 are the same, and a description is only given of the SS/V IN 27.

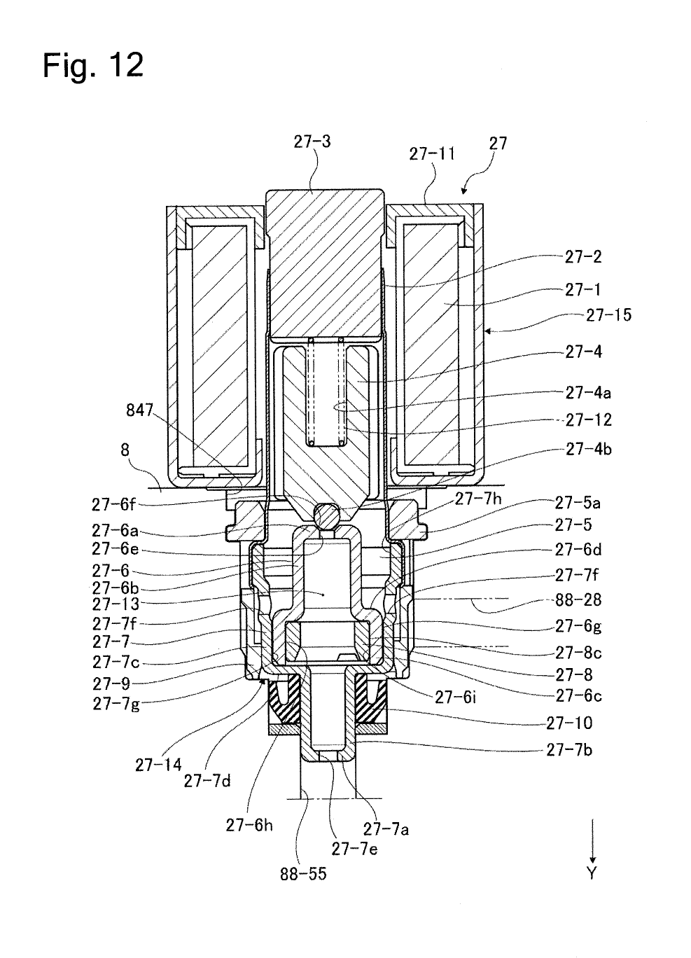

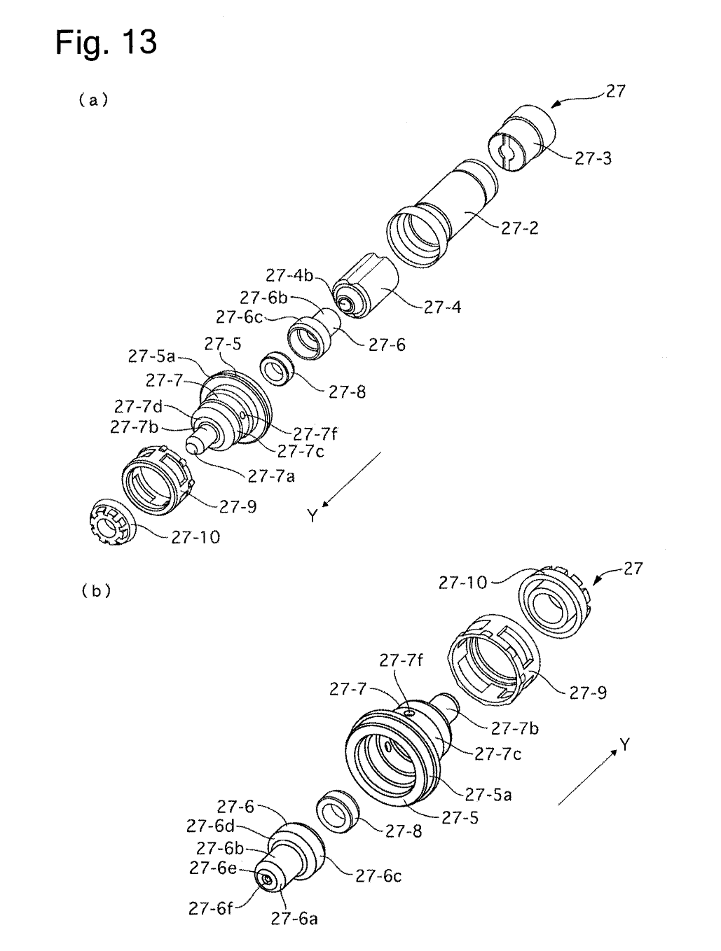

FIG. 12 is a longitudinal sectional view of the SS/V IN 27. FIG. 13 are exploded perspective views of the SS/V IN 27. FIG. 13(a) is a view as viewed from the positive side in the Y-axis direction, and FIG. 13(b) is a view as viewed from the negative side in the Y-axis direction.

The SS/V IN 27 includes a coil 27-1, a cylinder 27-2, a body center 27-3, an armature 27-4, a flange ring 27-5, a seat member 27-6, a body member 27-7, a first filter member 27-8, a second filter member 27-9, and a seal member 27-10. An electromagnetic drive part 27-15 is formed of the coil 27-1, the cylinder 27-2, and the armature 27-4.

The coil 27-1 is configured to generate an electromagnetic force through a current supply. The coil 27-1 is accommodated in a yoke 27-11 made of a magnetic material.

The cylinder 27-2 is made of a non-magnetic material formed into a tubular shape opened at both ends.

The body center 27-3 is made of a magnetic material. An end on the positive side in the Y-axis direction of the body center 27-3 is welded to an end on the negative side in the Y-axis direction of the cylinder 27-2. The body center 27-3 is configured to attract the armature 27-4 by the electromagnetic force generated by the coil 27-1 when the current is supplied to the coil 27-1.

The armature 27-4 is made of a magnetic material. The armature 27-4 is arranged along the Y-axis direction inside the cylinder 27-2. A recessed part 27-4a extending toward the positive side in the Y-axis direction is formed at an end on the negative side in the Y-axis direction of the armature 27-4. A coil spring 27-12 is provided in a compressed state between a bottom portion of the recessed part 27-4a and the body center 27-3. The coil spring 27-12 is configured to urge the armature 27-4 toward the positive side in the Y-axis direction. When a current is not supplied to the coil 27-1, a predetermined gap is provided between an end on the positive side in the Y-axis direction of the cylinder 27-2 and an end on the negative side in the Y-axis direction of the armature 27-4. A spherical valve body 27-4b is fixed to an end on the positive side in the Y-axis direction of the armature 27-4.

The flange ring 27-5 is made of a magnetic material formed into a tubular shape opened at both ends, and is arranged in the SS/V IN accommodating hole 847. The flange ring 27-5 includes a crimped part 27-5a increased in diameter, and fixed to the housing 8 through crimping.

The seat member 27-6 is arranged in the SS/V IN accommodating hole 847. The seat member 27-6 includes a bottom part 27-6a at an end on the negative side in the Y-axis direction, and is formed into a tubular shape having an opening 27-6i opened at an end on the positive side in the Y-axis direction. The seat member 27-6 includes a small-diameter part 27-6b, a large-diameter part 27-6c, and a first step part 27-6d. The small-diameter part 27-6b includes a bottom part 27-6a, and is provided on the negative side in the Y-axis direction. A first communication hole 27-6e is formed in the bottom part 27-6a. A valve seat 27-6f against which the valve body 27-4b of the armature 27-4 abuts is formed around the first communication hole 27-6e. The large-diameter part 27-6c is provided on the positive side in the Y-axis direction with respect to the small-diameter part 27-6b, and is formed so as to be larger in diameter than the small-diameter part 27-6b. The first step part 27-6d extends in a direction approximately orthogonal to the Y-axis direction, and connects the small-diameter part 27-6b and the large-diameter part 27-6c to each other.

The body member 27-7 is arranged in the SS/V IN accommodating hole 847, and is provided at a position outside the seat member 27-6. The body member 27-7 includes a bottom part 27-7a at an end on the positive side in the Y-axis direction, and is formed into a tubular shape having an opening 27-7h opened at an end on the positive side in the Y-axis direction. The body member 27-7 includes a small-diameter part 27-7b, a large-diameter part 27-7c, and a second step part 27-7d. The small-diameter part 27-7b includes a bottom part 27-7a, and is provided on the positive side in the Y-axis direction. A second communication hole 27-7e is formed in the bottom part 27-7a. The second communication hole 27-7e is connected to the fifth hole 88-55. The large-diameter part 27-7c is provided on the negative side in the Y-axis direction with respect to the small-diameter part 27-7b, and is formed so as to be larger in diameter than the small-diameter part 27-7b. The large-diameter part 27-6c of the seat member 27-6 is fitted to the large-diameter part 27-7c. The large-diameter part 27-7c is inserted in an inner periphery of an end on the positive side in the Y-axis direction of the cylinder 27-2. A tip end of the large-diameter part 27-7c is inserted to a position of abutment against a side surface on the positive side in the Y-axis direction of the crimped part 27-5a via the cylinder 27-2. The large-diameter part 27-7c is fixed by crimping an end on the positive side in the Y-axis direction of the cylinder 27-2 along an outer peripheral surface of the large-diameter part 27-7c. An inner abutment surface 27-7g that abuts against an outer peripheral surface 27-6g of the large-diameter part 27-6c of the seat member 27-6a is provided on an inner peripheral surface of the large-diameter part 27-7c. A plurality of circulation holes 27-7f are formed in the large-diameter part 27-7c on the negative side in the Y-axis direction with respect to the inner abutment surface 27-7g. The circulation holes 27-7f are connected to the eighth hole 88-28. The second step part 27-7d extends in a direction approximately orthogonal to the Y-axis direction, and connects the small-diameter part 27-7b and the large-diameter part 27-7c to each other. An internal space surrounded by the seat member 27-6 and the body member 27-7 is a flow passage (internal oil passage) 27-13 through which the brake fluid flows. A valve part 27-14 is formed of the seat member 27-6 and the body member 27-7.

The first filter member 27-8 is provided in the flow passage 27-13. The first filter member 27-8 is configured to filter the brake fluid flowing from the second communication hole 27-7e into the first communication hole 27-6e, to thereby prevent contamination and the like in the brake fluid from being transmitted to the armature 27-4 and the valve seat 27-6f. The first filter member 27-8 engages with the first step part 27-6d of the seat member 27-6 and the second step part 27-7d of the body member 27-7, to thereby maintain a position in the Y axis-direction. The first filter member 27-8 is provided so as to face an inner peripheral surface 27-6h of the large-diameter part 27-6c of the seat member 27-6. A gap smaller than coarseness of a mesh part 27-8a described later is provided between the inner peripheral surface 27-6h of the seat member 27-6 and the outer peripheral surface 27-8c of the first filter member 27-8. The shape of the first filter member 27-8 is the same as that of the first filter member 21-8 illustrated in FIG. 7, and a description thereof is therefore omitted. The first filter 27-8 is arranged in a state in which a recessed portion faces the positive side in the Y axis-direction.

A second filter member 27-9 is injection-molded of a resin material. The second filter member 27-9 is arranged at a position outside the body member 27-7, and overlaps the first filter member 27-8 in the Y-axis direction. The second filter member 27-9 is configured to filter the brake fluid flowing from the eighth hole 88-28 into the circulation holes 27-7f, to thereby prevent contamination and the like in the brake fluid from being transmitted to the armature 27-4 and the valve seat 27-6f.

The seal member 27-10 is a cup seal, and is mounted on an outer periphery of the small-diameter part 27-7b of the body member 27-7. The seal member 22-10 is configured to function as the check valve 270 by sealing a leak of the brake fluid from the eighth hole 88-28 to the fifth hole 88-55 when (hydraulic pressure in eighth hole 88-28>hydraulic pressure in fifth hole 88-55), and permitting a flow of the brake fluid from the fifth hole 88-55 to the eighth hole 88-28 when (hydraulic pressure in eighth hole 88-28<hydraulic pressure in oil passage hole 880).

A description is now given of an operation of the SS/V 11\127.

When the current is not supplied to the coil 27-1, the armature 27-4 is urged by an urging force of the coil spring 27-12 toward the positive side in the Y-axis direction, and the valve body 27-4b of the armature 27-4 thus abuts against the valve seat 27-6f. Therefore, the fifth hole 88-55 and the eighth hole 88-28 are shut off from each other.

When a predetermined current is supplied to the coil 27-1, a magnetic path is formed in the yoke 27-11, the body center 27-3, and the armature 27-4, and an attraction force is generated between the body center 27-3 and the armature 27-4. The armature 27-4 moves toward the negative side in the Y-axis direction by the attraction force, and when the valve body 27-4b of the armature 27-4 separates from the valve seat 27-6f, the fifth hole 88-55 and the eighth hole 88-28 communicate with each other via the circulation holes 27-7f, the axial oil passage 27-5g, the first communication hole 27-6e, and the second communication hole 23-7e.

In the following description, reference numeral of each component of the SS/V OUT 28 is obtained by replacing 27 of the reference numeral of the same component of the SS/V IN 27 with 28.

[SOL/V OUT]

FIG. 13 is a longitudinal sectional view of the SOL/V OUT 25.

The SOL/V OUT 25 includes a coil 25-1, a cylinder 25-2, a body center 25-3, an armature 25-4, a flange ring 25-5, a seat member 25-6, a body member 25-7, a first filter member 25-8, a second filter member 25-9, and a seal member 25-10. An electromagnetic drive part 25-15 is formed of the coil 25-1, the cylinder 25-2, and the armature 25-4.

The coil 25-1 is configured to generate an electromagnetic force through a current supply. The coil 25-1 is accommodated in a yoke 25-11 made of a magnetic material.

The cylinder 25-2 is made of a non-magnetic material formed into a tubular shape opened at both ends.

The body center 25-3 is made of a magnetic material. An end on the positive side in the Y-axis direction of the body center 25-3 is welded to an end on the negative side in the Y-axis direction of the cylinder 25-2. The body center 25-3 is configured to attract the armature 25-4 by the electromagnetic force generated by the coil 25-1 when the current is supplied to the coil 25-1.

The armature 25-4 is made of a magnetic material. The armature 25-4 is arranged along the Y-axis direction inside the cylinder 25-2. A recessed part 25-4a extending toward the positive side in the Y-axis direction is formed at an end on the negative side in the Y-axis direction of the armature 25-4. A coil spring 25-12 is provided in a compressed state between a bottom portion of the recessed part 25-4a and the body center 25-3. The coil spring 25-12 is configured to urge the armature 25-4 toward the positive side in the Y-axis direction. When a current is not supplied to the coil 25-1, a predetermined gap is provided between an end on the positive side in the Y-axis direction of the cylinder 25-2 and an end on the negative side in the Y-axis direction of the armature 25-4. A spherical valve body 25-4b is fixed to an end on the positive side in the Y-axis direction of the armature 25-4.

The flange ring 25-5 is made of a magnetic material formed into a tubular shape opened at both ends, and is arranged in the communication valve accommodating hole 843. The flange ring 25-5 includes a crimped part 25-5a increased in diameter, and fixed to the housing 8 through crimping.

The seat member 25-6 is arranged in the SOL/V OUT accommodating hole 845. The seat member 25-6 includes a bottom part 25-6a at an end on the negative side in the Y-axis direction, and is formed into a tubular shape having an opening 25-6i opened at an end on the positive side in the Y-axis direction. The seat member 25-6 includes a small-diameter part 25-6b, a large-diameter part 25-6c, and a first step part 25-6d. The small-diameter part 25-6b includes a bottom part 25-6a, and is provided on the negative side in the Y-axis direction. A first communication hole 25-6e is formed in the bottom part 25-6a. A valve seat 25-6f against which the tip part 25-4b of the armature 25-4 abuts is formed around the first communication hole 25-6e. The large-diameter part 25-6c is provided on the positive side in the Y-axis direction with respect to the small-diameter part 25-6b, and is formed so as to be larger in diameter than the small-diameter part 25-6b. The first step part 25-6d extends in a direction approximately orthogonal to the Y-axis direction, and connects the small-diameter part 25-6b and the large-diameter part 25-6c to each other.

The body member 25-7 is arranged in the SOL/V OUT accommodating hole 845, and is provided at a position outside the seat member 25-6. The body member 25-7 includes a bottom part 25-7a at an end on the positive side in the Y-axis direction, and is formed into a tubular shape having an opening 25-7h opened at an end on the positive side in the Y-axis direction. The body member 25-7 includes a small-diameter part 25-7b, a large-diameter part 25-7c, and a second step part 25-7d. The small-diameter part 25-7b includes a bottom part 25-7a, and is provided on the positive side in the Y-axis direction. A second communication hole 25-7e is formed in the bottom part 25-7a. The second communication hole 25-7e is connected to the first hole 88-41. The large-diameter part 25-7c is provided on the negative side in the Y-axis direction with respect to the small-diameter part 25-7b, and is formed so as to be larger in diameter than the small-diameter part 25-7b. The large-diameter part 25-6c of the seat member 25-6 is fitted to the large-diameter part 25-7c. The large-diameter part 25-7c is inserted in an inner periphery of an end on the positive side in the Y-axis direction of the cylinder 25-2. A tip end of the large-diameter part 25-7c is inserted to a position of abutment against a side surface on the positive side in the Y-axis direction of the crimped part 25-5a via the cylinder 25-2. The large-diameter part 25-7c is fixed by crimping an end on the positive side in the Y-axis direction of the cylinder 25-2 along an outer peripheral surface of the large-diameter part 25-7c. An inner abutment surface 25-7g that abuts against an outer peripheral surface 25-6g of the large-diameter part 25-6c of the seat member 25-6a is provided on an inner peripheral surface of the large-diameter part 25-7c. A plurality of circulation holes 25-7f are formed in the large-diameter part 25-7c on the negative side in the Y-axis direction with respect to the inner abutment surface 25-7g. The circulation holes 25-7f are connected to the sixth hole 88-26. The second step part 25-7d extends in a direction approximately orthogonal to the Y-axis direction, and connects the small-diameter part 25-7b and the large-diameter part 25-7c to each other. An internal space surrounded by the seat member 25-6 and the body member 25-7 is a flow passage (internal oil passage) 25-13 through which the brake fluid flows. A valve part 25-14 is formed of the seat member 25-6 and the body member 25-7.

A second filter member 25-9 is injection-molded of a resin material. The second filter member 25-9 is arranged at a position outside the body member 25-7. The second filter member 25-9 is configured to filter the brake fluid flowing from the oil passage hole 880 into the circulation holes 25-7f, to thereby prevent contamination and the like in the brake fluid from being transmitted to the armature 25-4 and the valve seat 25-6f.

The seal member 25-10 is an O ring, and is mounted on an outer periphery of the small-diameter part 25-7b of the body member 25-7, to thereby seal a gap between an outer peripheral surface of the small-diameter part 25-7b and an inner peripheral surface of the SOL/V OUT accommodating hole 845.

A description is now given of an operation of the SOL/V OUT25.

When the current is not supplied to the coil 25-1, the armature 25-4 is urged by an urging force of the coil spring 25-12 toward the positive side in the Y-axis direction, and the tip part 25-4b of the armature 25-4 thus abuts against the valve seat 25-6f. Therefore, the oil passage hole 880 and the first hole 88-41 are shut off from each other.

When a predetermined current is supplied to the coil 25-1, a magnetic path is formed in the yoke 25-11, the body center 25-3, and the armature 25-4, and an attraction force is generated between the body center 25-3 and the armature 25-4. The armature 25-4 moves toward the negative side in the Y-axis direction by the attraction force, and when the tip part 25-4b of the armature 25-4 separates from the valve seat 25-6f, the oil passage hole 880 and the first hole 88-41 communicate with each other via the circulation holes 25-7f, the axial oil passage 25-5g, the first communication hole 25-6e, and the second communication hole 25-7e.

[Formation of Seat Members and Body Members]

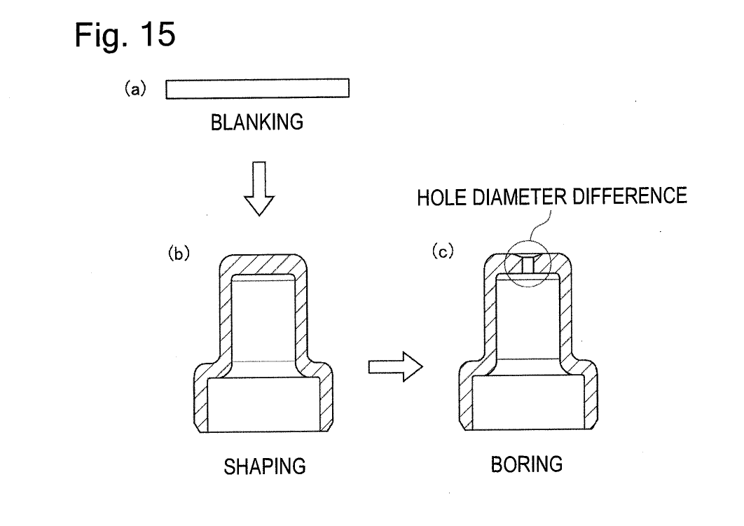

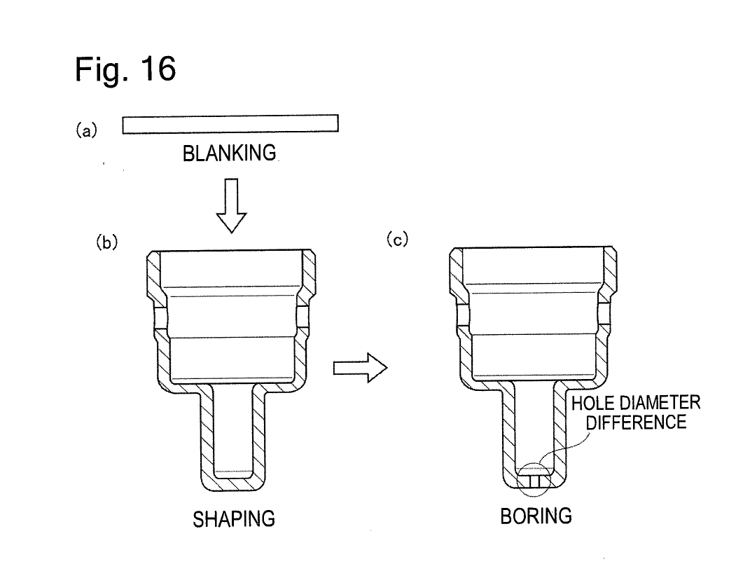

The seat members and the body members of the normally-closed electromagnetic valve and the normally-open electromagnetic valve are different in diameter between the first communication hole and the second communication hole, but the other portions are common portions. FIG. 15 are views for illustrating a formation method for the seat member. FIG. 16 are views for illustrating a formation method for the body member.

As illustrated in FIG. 15 and FIG. 16, each of the seat member and the body member is formed into a rough shape by blanking (pressing) a sheet material. The, shaping is carried out by deburring, chamfering, and the like. Finally, the first communication hole and the second communication hole having diameters different depending on the electromagnetic valves are bored, and the forming is completed.

[Common Heights of Top Portion and Bottom Portion]

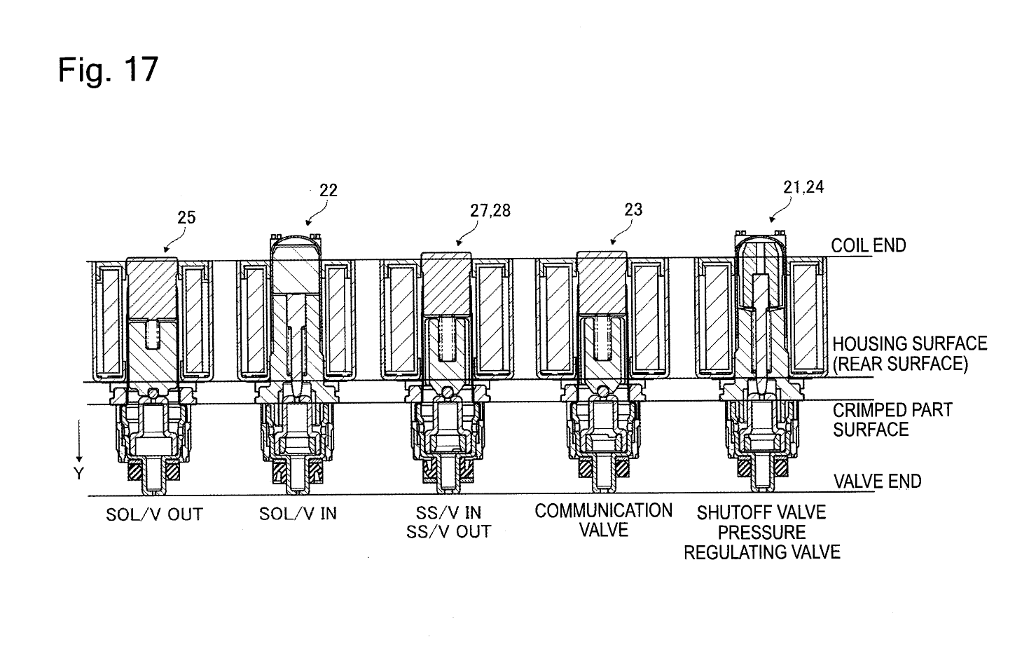

FIG. 17 is a view for illustrating comparison of heights of the respective electromagnetic valves when valve ends (tips of the body members) of the respective electromagnetic valves are aligned on the same line.

As illustrated in FIG. 17, heights of the respective electromagnetic valves from the valve ends to surfaces on the positive side in the Y-axis direction of the crimped parts are equal to one another. The height (bottom-portion height) from the valve end to the surface on the positive side in the Y-axis direction of each of the electromagnetic valves is determined by the abutment of the body member of the normally-closed electromagnetic valve against the crimped part of the flange ring across the cylinder. A press-in amount of the seat member into the valve body of the normally-open electromagnetic valve is adjusted in accordance with the bottom-portion height determined by the normally-closed electromagnetic valve. Depths of the accommodating holes of the respective electromagnetic valves of the housing 8 can be set to be constant by equalizing the bottom-portion heights of the respective electromagnetic valves to one another.

Moreover, as illustrated in FIG. 17, heights from a plane of the housing 8 to the ends of the coils of the respective electromagnetic valves are equal to one another. The heights (top-portion heights) from the plane of the housing 8 to the ends of the coils of the respective electromagnetic valves are determined by heights of the coils. Heights of the yokes of the electromagnetic valves can be set to be constant.

[Actions]

The normally-closed electromagnetic valve and the normally-open electromagnetic valve having hitherto been employed are separately designed due to the differences in structure, and are thus different in length of the mounting portion mounted to the housing 8. Thus, the degree of freedom in layout of the oil passages inside the housing 8 is limited, and the vehicle mountability may be degraded.

Thus, in the first embodiment, the axial length of the valve part 21-14 of the normally-open electromagnetic valve (such as the shutoff valve 21) is set to be equal to the axial length of the valve part 27-14 of the normally-closed electromagnetic valve (such as the SS/V IN 27). As a result, the depths of the accommodating holes of the housing 8 configured to accommodate the respective electromagnetic valves can be set to be equal to one another, thereby being capable of improving the degree of freedom in layout of the oil passages in the housing 8.

Moreover, in the first embodiment, the SS/V IN accommodating hole 847 of the housing 8 in which the valve part 21-14 of the normally-open electromagnetic valve (such as the shutoff valve 21) is arranged and the shutoff valve accommodating hole 841 of the housing 8 in which the valve part 27-14 of the normally-closed electromagnetic valve (such as the SS/V IN 27) is arranged are set to be equal to each other in depth from the surface of the housing 8. As a result, a thickness and a size of the housing 8 can be decreased, thereby being capable of suppressing an amount of machining when the accommodating holes are machined.

Moreover, in the first embodiment, both the SS/V IN accommodating hole 847 configured to accommodate the normally-closed electromagnetic valve (such as the SS/V IN 27) and the shutoff valve accommodating hole 841 configured to accommodate the normally-open electromagnetic valve (such as the shutoff valve 21) are formed so as to extend from the one surface of the housing 8 to the inside of the housing 8. As a result, the thickness and the size of the housing 8 can be decreased. Moreover, ease of machining of the accommodating holes can be improved. Further, the electromagnetic valves can be mounted from the one side surface of the housing 8, thereby being capable of improving workability.

Moreover, in the first embodiment, the valve part 27-14 of the normally-closed electromagnetic valve (such as the SS/V IN 27) and the valve part 21-14 of the normally-open electromagnetic valve (such as the shutoff valve 21) are caused to have the common portions. As a result, the valve part of the normally-closed electromagnetic valve and the valve part of the normally-open electromagnetic valve have the common portions, and most portions of both the valve parts can be common. Thus, the productivity of the electromagnetic valves can be improved.

Moreover, in the first embodiment, in the seat member 27-6 forming the valve part 27-14 of the normally-closed electromagnetic valve (such as the SS/V IN 27) and the seat member 21-6 forming the valve part 21-14 of the normally-open electromagnetic valve (such as the shutoff valve 21), the common portions having common shapes correspond to a portion other than the first communication hole 27-6e of the seat member 27-6 and a portion other than the first communication hole 21-6e of the seat member 21-6. As a result, while the first communication holes are set in accordance with characteristics of the respective electromagnetic valves, the other portions of the seat members can be the common portions, and the productivity of the electromagnetic valves can thus be improved.

Moreover, in the first embodiment, in the body member 27-7 forming the valve part 27-14 of the normally-closed electromagnetic valve (such as the SS/V IN 27) and the body member 21-7 forming the valve part 21-14 of the normally-open electromagnetic valve (such as the shutoff valve 21), the common portions having common shapes correspond to a portion other than the second communication hole 27-7e of the body member 27-7 and a portion other than the second communication hole 21-7e of the body member 21-7. As a result, while the second communication holes are set in accordance with characteristics of the respective electromagnetic valves, the other portions of the body members can be the common portions, and the productivity of the electromagnetic valves and thus be improved.

Moreover, in the first embodiment, the normally-closed electromagnetic valve (such as the SS/V IN 27) includes the electromagnetic drive part 27-15 formed of the coil 27-1, the cylinder 27-2, and the armature 27-4, and the normally-open electromagnetic valve (such as the shutoff valve 21) includes the electromagnetic drive part 21-15 formed of the coil 21-1, the cylinder 21-2, the armature 21-3, and the valve body 21-5. As a result, the valve parts having the common portions can be mounted in the normally-closed electromagnetic valve and the normally-open electromagnetic valve including the components different from each other.

Moreover, in the first embodiment, the seat member 27-6 and the body member 27-7 of the normally-closed electromagnetic valve (such as the SS/V IN 27) and the seat member 21-6 and the body member 21-7 of the normally-open electromagnetic valve (such as the shutoff valve 21) are formed through the press forming. As a result, the productivity of the seat member and the body member can be improved.

Moreover, in the first embodiment, the SOL/V OUT accommodating hole 845 and the SOL/V IN accommodating hole 842 of the housing 8 are arranged so as to be adjacent to each other, and the oil passage hole 880 configured to connect the SOL/V OUT accommodating hole 845 and the SOL/V IN accommodating hole 842 to each other out of the oil passages to each other is formed along the one surface of the housing 8. As a result, the oil passage hole 880 does not need to be formed so as to be inclined with respect to the surface of the housing 8, and the size of the housing 8 can thus be decreased.

Moreover, in the first embodiment, the axial lengths of the coil 27-1 of the normally-closed electromagnetic valve (such as the SS/V IN 27) and the coil 27-1 of the normally-open electromagnetic valve (such as the shutoff valve 21) are set to be equal. As a result, the yokes can be common. Moreover, a size of the entire second unit 1B can be decreased.

[Effects]

A description is given of effects in a case in which the SS/V IN 27 is applied as the normally-closed electromagnetic valve, and the shutoff valve 21 is applied as the normally-open electromagnetic valve. The same effects can be provided in a case in which the communication valve 23, the SOL/V OUT 25, and the SS/V OUT 28 are applied as the normally-closed electromagnetic valves, and the SOL/V IN 22 is applied as the normally-open electromagnetic valve (except for (9)).

(1) The hydraulic pressure control device includes: the housing 8, which internally includes the oil passage; the SS/V IN 27 (normally-closed electromagnetic valve), which includes the valve part 27-14 (first valve part) arranged so as to extend from the surface of the housing 8 to the inside of the housing 8, and is configured to close the oil passage when a current is not supplied; and the shutoff valve 21 (normally-open electromagnetic valve), which includes the valve portion 21-14 (second valve part) being arranged so as to extend from the surface of the housing 8 to the inside of the housing 8, and having an axial length set to be equal to an axial length of the valve part 27-14 (first valve part), and is configured to open the oil passage when a current is not supplied.

Thus, the depths of the accommodating holes of the housing 8 configured to accommodate the respective electromagnetic valves can be set to be equal to one another, thereby being capable of improving the degree of freedom in layout of the oil passages inside the housing 8.

(2) The housing 8 has the SS/V IN accommodating hole 847 (first hole part) in which the valve part 27-14 (first valve part) is arranged and the shutoff valve accommodating hole 841 (second hole part), which is set to be equal to the SS/V IN accommodating hole 847 (first hole part) in depth from the surface of the housing 8, and in which the valve part 21-14 (second valve part) is arranged.

Thus, the thickness and the size of the housing 8 can be decreased, thereby being capable of suppressing the amount of machining when the accommodating holes are machined.

(3) Both the SS/V IN accommodating hole 847 (first hole part) and the shutoff valve accommodating hole 841 (second hole part) are formed so as to extend from the one surface of the housing 8 to the inside of the housing 8.

Thus, the thickness and the size of the housing 8 can be decreased. Moreover, the ease of machining of the accommodating holes can be improved. Further, the electromagnetic valves can be mounted from the one side surface of the housing 8, thereby being capable of improving workability.

(4) The valve part 27-14 (first valve part) and the valve part 21-14 (second valve part) include the common portions having the common shapes.

Thus, the valve part of the normally-closed electromagnetic valve and the valve part of the normally-open electromagnetic valve have the common portions, and most portions of both the valve parts can be common, and the productivity of the electromagnetic valves can thus be improved.

(5) The valve part 27-14 (first valve part) includes: the seat member 27-6 (first member), which is formed into a bottomed tubular shape having the opening 27-6i (first opening) opened at one end, and has the first communication hole 27-6e (first passage hole) formed in a bottom wall along an axial direction, and used to open/close the oil passage; and the body member 27-7 (second member), which is formed into the bottomed tubular shape having the opening 27-7h (second opening) opened at one end, is fixed from the opening 27-7h (second opening) side to the opening 27-6i (first opening) in the axial direction, and has the second communication hole 27-7e (second passage hole) being formed in the bottom wall, and communicating with the first communication hole 27-6e (first passage hole) in the axial direction, and at least one circulation hole 27-7f (first through hole) formed in the peripheral wall along the radial direction. The valve portion 21-14 (second valve part) includes: the seat member 21-6 (third member), which is formed into a bottomed tubular shape having the opening 21-6i (third opening) opened at one end, and has the first communication hole 21-6e (third passage hole) formed in the bottom wall along the axial direction, and used to open/close the oil passage; and the body member 21-7 (fourth member), which is formed into a bottomed tubular shape having the opening 21-7h (fourth opening) opened at one end, is fixed from the opening 21-7h (fourth opening) side to the opening 21-6i (third opening) in the axial direction, and has the second communication hole 21-7e (fourth passage hole) being formed in the bottom wall, and communicating with the first communication hole 27-6e (first passage hole) in the axial direction, and at least one circulation hole 21-7f (second through hole) formed in a peripheral wall along a radial direction. The common portions having common shapes correspond to the portion of the seat member 27-6 (first member) other than the first communication hole 27-6e (first passage hole) and the portion of the seat member 21-6 (third member) other than the first communication hole 21-6e (third passage hole).

Thus, while the first communication holes are set in accordance with the characteristics of the respective electromagnetic valves, the other portions of the seat members can be the common portions, and the productivity of the electromagnetic valves can thus be improved.

(6) The common portions having common shapes correspond to the portion of the body member 27-7 (second member) other than the second communication hole 27-7e (second passage hole) and the portion of the body member 21-7 (fourth member) other than the second communication hole 21-7e (fourth passage hole).

Thus, while the second communication holes are set in accordance with the characteristics of the respective electromagnetic valves, the other portions of the body members can be the common portions, and the productivity of the electromagnetic valves can thus be improved.

(7) The SS/V IN27 (normally-closed electromagnetic valve) includes the electromagnetic drive part 27-15 (first electromagnetic drive part) including: the coil 27-1 (first electromagnetic coil), which is provided so as to extend from the surface of the housing 8 to the outside of the housing 8, and is configured to generate an electromagnetic force when a current is supplied; the cylinder 27-2 (tubular member), which is made of a non-magnetic material, is arranged on the inner periphery of the coil 27-1 (first electromagnetic coil), and is connected to the opening 27-7h (second opening) side of the body member 27-7 (second member) at the valve part 27-14 (first valve part); and the armature 27-4 (first movable member), which is formed of a magnetic body, is movably provided on the inner periphery of the cylinder 27-2 (tubular member), moves in the axial direction through the attraction force of the coil 27-1 (first electromagnetic coil), and includes the valve body 27-4b (first valve body) used to open/close the first communication hole 27-6e (first passage hole) on the tip side.

The shutoff valve 21 (normally-open electromagnetic valve) includes the electromagnetic drive part 21-15 (second electromagnetic drive part) including: the coil 21-1 (second electromagnetic coil), which is provided so as to extend from the surface of the housing 8 to the outside of the housing 8, and is configured to generate an electromagnetic force when a current is supplied; the valve body 21-5 (fixed member), which is made of a magnetic material, is arranged on the inner periphery of the coil 21-1 (second electromagnetic coil), and is connected to the bottom wall side of the seat member 21-6 (third member) at the valve part 21-14 (second valve part); the cylinder 21-2 (cup-shaped member), which is made of a non-magnetic material, is arranged on the inner periphery of the coil 21-1 (second electromagnetic coil), and accommodates one end of the valve body 21-5 (fixed member); and the plunger 21-4 (second movable member), which is formed of a magnetic body, is movably provided on the inner periphery of the cylinder 21-2 (cup-shaped member), moves in the axial direction through the attraction force of the coil 21-1 (second electromagnetic coil), and includes the tip part 21-4b (second valve body) used to open/close the first communication hole 21-6e (third passage hole) on the tip side.

Thus, the valve parts having the common portions can be mounted in the normally-closed electromagnetic valve and the normally-open electromagnetic valve including the components different from each other.

(8) The seat member 27-6 (first member), the body member 27-7 (second member), the seat member 21-6 (third member), and the body member 21-7 (fourth member) are formed through press forming.

Thus, the productivity of the seat member and the body member can be improved.

(9) The SOL/V OUT accommodating hole 845 (first hole part) and the SOL/V IN accommodating hole 842 (second hole part) are arranged so as to be adjacent to each other, and the oil passage hole 880 configured to connect the SOL/V OUT accommodating hole 845 (first hole part) and the SOL/V IN accommodating hole 842 (second hole part) to each other out of the oil passage is formed along the one surface of the housing 8.

Thus, the oil passage hole 880 does not need to be formed so as to be inclined with respect to the surface of the housing 8, and the size of the housing 8 can thus be decreased.

(10) The SS/V IN 27 (normally-closed electromagnetic valve) includes the electromagnetic drive part 27-15 (first electromagnetic drive part) including the coil 27-1 (first electromagnetic coil), which is provided so as to extend from the surface of the housing 8 to the outside of the housing 8, and is configured to generate an electromagnetic force through a current supply. The shutoff valve 21 (normally-open electromagnetic valve) includes the electromagnetic drive part 21-15 (second electromagnetic drive part) including the coil 21-1 (second electromagnetic coil), which is provided so as to extend from the surface of the housing 8 to the outside of the housing 8, is configured to generate an electromagnetic force through a current supply, and has the axial length set to be equal to the axial length of the coil 27-1 (first electromagnetic coil).

Thus, the yokes can be common. Moreover, the size of the entire second unit 1B can be decreased.

(13) The hydraulic pressure control device includes: the housing 8, which internally includes the oil passage; the SS/V IN27 (normally-closed electromagnetic valve), which includes the valve part 27-14 (first valve part) arranged so as to extend from the surface of the housing 8 to the inside of the housing 8, and is configured to close the oil passage when a current is not supplied; and the shutoff valve 21 (normally-open electromagnetic valve), which includes the valve part 21-14 (second valve part) being arranged so as to extend from the surface of the housing 8 to the inside of the housing 8, having the axial length set to be equal to the axial length of the valve part 27-14 (first valve part) through inclusion of the common portion having the shape common to the valve part 27-14 (first valve part), and is configured to open the oil passage when a current is not supplied.

Thus, the valve part of the normally-closed electromagnetic valve and the valve part of the normally-open electromagnetic valve have the common portions, and hence most portions of both the valve parts can be common. Thus, the productivity of the electromagnetic valves can be improved.

(16) The brake system includes: the first unit 1A including: the master cylinder 5, which is configured to generate the brake hydraulic pressure through the brake operation of a driver; and the stroke simulator 6, into which the brake fluid having flowed out from the master cylinder 5 flows, and which is configured to generate a simulated operation reaction force of the brake pedal 100 (brake operation member); and the second unit 1B integrally including: the housing 8, which is connected to the first unit 1A, and internally includes the oil passage; the pump 3 (hydraulic pressure source), which is provided to the inside of the housing 8, and is configured to generate an operation hydraulic pressure for the wheel cylinder W/C provided to a wheel via the oil passage; the SS/V IN 27 (electromagnetic switching valve), which is a normally-closed electromagnetic valve including the valve part 27-14 (first valve part) arranged so as to extend from the surface of the housing 8 to the inside of the housing 8, and being configured to close when a current is not supplied, and is configured to permit an inflow of the brake fluid into the stroke simulator 6; the shutoff valve 21 (electromagnetic shutoff valve), which is a normally-open electromagnetic valve including the valve part 21-14 (second valve part) being arranged so as to extend from the surface of the housing 8 to the inside of the housing 8, including the common portion having the shape common to the valve part 27-14 (first valve part), and being configured to open when a current is not supplied, and is configured to switch the communication state of the oil passage between the master cylinder 8 and the wheel cylinder W/C; and the ECU 90 (control unit), which is configured to drive the pump 3 (hydraulic pressure source), the shutoff valve 21 (electromagnetic shutoff valve), and the SS/V IN 27 (electromagnetic switching valve).

Thus, the valve part of the normally-closed electromagnetic valve and the valve part of the normally-open electromagnetic valve have the common portions, and hence most portions of both the valve parts can be common. Thus, the productivity of the electromagnetic valves can be improved.

### Other Embodiments

The present invention have been described above based on the first embodiment. However, the specific configuration of the present invention is not limited to the first embodiment. A change in design without departing from the scope of the gist of the invention is encompassed in the present invention.

In the first embodiment, the valve parts of the normally-closed electromagnetic valves and the valve parts of the normally-open electromagnetic valves including the common portions are used. However, it is not always required that the valve parts of the normally-closed electromagnetic valves and the valve parts of the normally-open electromagnetic valves include the common portions.

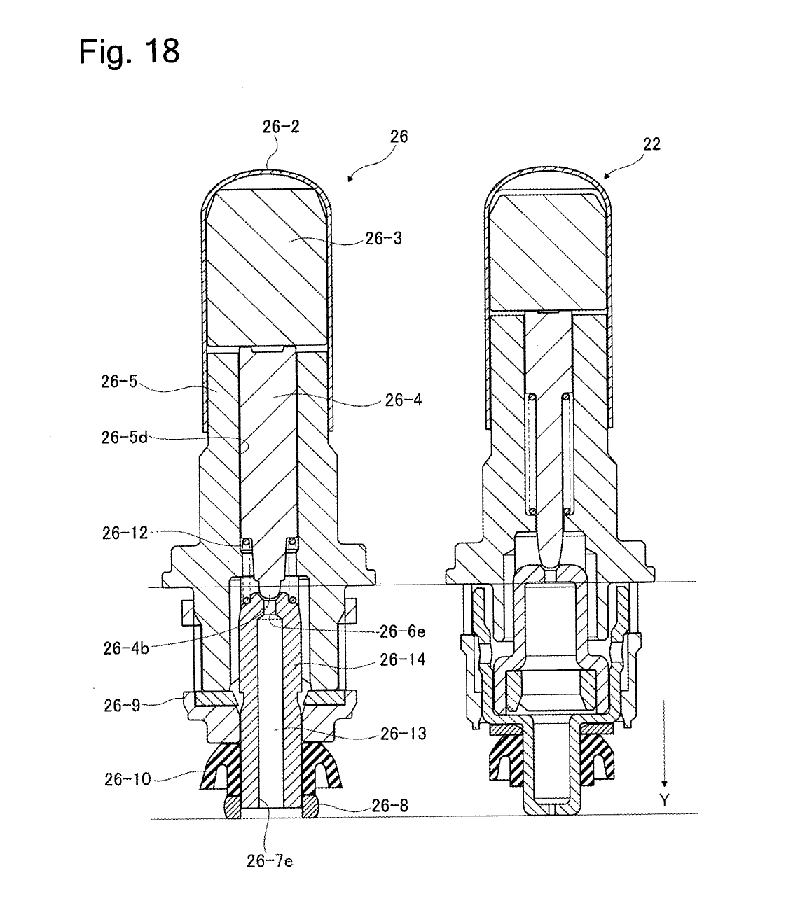

FIG. 18 is a cross-sectional view of the SOL/V IN 22 in the first embodiment as an example of the normally-closed electromagnetic valve and a cross-sectional view of a SOL/V IN 26 including a different valve part. The SOL/V IN 22 in the first embodiment is described in detail with reference to FIG. 8 in the first embodiment, and reference symbols are thus omitted in FIG. 18.

The SOL/V IN 26 includes a cylinder 26-2, an armature 26-3, a plunger 26-4, a valve body 26-5, a valve part 26-14, a first filter member 26-8, a second filter member 26-9, and a seal member 21-10.

A first communication hole 26-6e is formed on the negative side of the valve part 26-14 in the Y-axis direction. A second communication hole 26-7e is formed on the positive side in the Y-axis direction of the valve part 26-14. A spring seat part to which an end of the coil spring 26-12 is mounted is formed on an outer periphery of the first communication hole 26-6e. A flow passage 22-13 extending in the axial direction is formed inside the valve part 26-14. The second filter member 26-9 is provided at an opening portion of the second communication hole 26-7e.

The plunger 26-4 is made of a non-magnetic material such as resin formed into a rod shape. The negative side in the Y-axis direction of the plunger 26-4 is connected to the armature 26-3. A spring seat part to which the coil spring 26-12 is mounted is formed on an end of the plunger 26-4 on the positive side in the Y-axis direction. The plunder 26-4 is formed so as to be tapered from the spring seat part toward the end side on the positive side in the Y-axis direction. A tip part 26-4b is formed into a semispherical shape.

The valve body 26-5 has a first accommodating hole 26-5d passing therethrough in the axial direction. The plunger 26-4 and the valve part 26-14 are accommodated in the first accommodating hole 26-5d.

The SOL/V IN 22 and the SOL/V IN 26 in the first embodiment are different from each other in the following point. That is, the valve part 22-24 of the SOL/V IN 22 is formed of the seat member 22-6 and the body member 22-7 whereas a valve 26-24 of the SOL/V N 26 is integrally formed. The valve body may be integrally formed as the valve 26-24 of the SOL/V IN 26, and is not specifically limited as long as the heights of the bottom portions of the respective electromagnetic valves are equal to one another.

The present invention may have configurations as described below.

(14) In the hydraulic pressure control device described in the item (13), the housing has:

a first hole part, in which the first valve part is arranged; and

a second hole part, which is set to be equal to the first hole part in depth from the surface of the housing, and in which the second valve part is arranged.

(15) In the hydraulic pressure control device described in the item (14), both the first hole part and the second hole part are formed so as to extend from one surface of the housing to the inside of the housing.

(17) In the braking system described in the item (16), the housing has:

a first hole part, in which the first valve part is arranged; and

a second hole part, which is set to be equal to the first hole part in depth from the surface of the housing, and in which the second valve part is arranged.

(18) In the braking system described in the item (17), both the first hole part and the second hole part are formed so as to extend from one surface of the housing, to which the control unit is mounted, to the inside of the housing.

(11) In the hydraulic pressure control device described in the item (1),

the first valve part includes:
a first member, which is formed into a bottomed tubular shape having a first opening opened at one end, and has a first passage hole formed in a bottom wall along an axial direction, and used to open/close the oil passage; and
a second member, which is formed into a bottomed tubular shape having a second opening opened at one end, is fixed to the first opening from the second opening side in the axial direction, and has a second passage hole being formed in a bottom wall, and communicating with the first passage hole in the axial direction, and at least one first through hole formed in a peripheral wall along a radial direction,

the second valve part includes:
a third member, which is formed into a bottomed tubular shape having a third opening opened at one end, and has a third passage hole formed in a bottom wall along the axial direction, and used to open/close the oil passage; and
a fourth member, which is formed into a bottomed tubular shape having a fourth opening opened at one end, is fixed to the third opening from the fourth opening side in the axial direction, and has a fourth passage hole being formed in a bottom wall, and communicating with the third passage hole in the axial direction, and at least one second through hole formed in a peripheral wall along the radial direction,

common shapes are formed of a shape of a portion of the first member other than the first opening and a shape of a portion of the third member other than the third opening, and

common shapes are formed of a shape of a portion of the second member other than the second opening and a shape of a portion of the fourth member other than the fourth opening.

(12) In the hydraulic pressure control device described in the above-mentioned item (11),

the normally-closed electromagnetic valve includes a first electromagnetic drive part including:
a first electromagnetic coil, which is provided so as to extend from a surface of the housing to an outside of the housing, and is configured to generate an electromagnetic force when a current is supplied;
a tubular member, which is made of a non-magnetic material, is arranged on an inner periphery of the first electromagnetic coil, and is connected to the second opening side of the second member at the first valve part; and
a first movable member, which is formed of a magnetic body, is movably provided on an inner periphery of the tubular member, moves in the axial direction through an attraction force of the first electromagnetic coil, and includes a first valve body used to open/close the first passage hole on a tip side, and

the normally-open electromagnetic valve includes a second electromagnetic drive part including:
a second electromagnetic coil, which is provided so as to extend from the surface of the housing to the outside of the housing, and is configured to generate an electromagnetic force when a current is supplied;
a fixed member, which is formed of a magnetic material, is arranged on an inner periphery of the second electromagnetic coil, and is connected to a bottom wall side of the third member at the second valve part;
a cup-shaped member, which is made of a non-magnetic material, is arranged on the inner periphery of the second electromagnetic coil, and accommodates one end of the fixed member; and
a second movable member, which is formed of a magnetic body, is movably provided on an inner periphery of the cup-shaped member, moves in the axial direction through an attraction force of the second electromagnetic coil, and includes a second valve body used to open/close the third passage hole on a tip side.

(19) The normally-open electromagnetic valve includes:

a coil, which forms a magnetic field when a current is supplied,

a yoke, which is made of a magnetic material, and is configured to accommodate the coil,

an armature, which is formed of a magnetic body, is arranged on an inner peripheral side of the yoke, and moves in an axial direction of the coil when a current is supplied to the coil,

a plunger, which is formed of a non-magnetic body, and moves along with the movement of the armature,

a valve body, which is formed into a tubular shape, and internally accommodates the plunger so as to be movable in the axial direction,

a valve part, which includes a first member being formed into a bottomed tubular shape having a first opening opened at one end, and having a first passage hole opened/closed by a tip part of the plunger on a bottom wall, and a second member being formed into a bottomed tubular shape having a second opening opened at one end, being fixed from the second opening side to the first opening in the axial direction, and having a second passage hole being formed in a bottom wall, and communicating with the first passage hole, and at least one first through hole formed in a peripheral wall along a radial direction, and

a coil spring, which is arranged between a reception part formed in the plunger and a reception part formed in the valve body so as to surround the plunger, and is configured to urge the plunger in a direction departing from the first communication hole.

A bottom wall side of the first member is inserted inside the valve body, thereby fixing the valve to the valve body.

A description has been given of only some embodiments of the present invention, but it is readily understood by a person skilled in the art that various changes and improvements can be made to the exemplified embodiments without practically departing from the novel teachings and advantages of the present invention. Thus, forms to which such changes and improvements are made are also intended to be included in the technical scope of the present invention. The above-mentioned embodiments may be arbitrarily combined.

The present application claims priority from the Japanese Patent Application No. 2015-209968 filed on Oct. 26, 2015. The entire disclosure including Specification, Scope of Claims, Drawings, and Abstract of Japanese Patent Application No. 2015-209968 filed on Oct. 26, 2015 is incorporated herein in its entirety by reference.

### REFERENCE SIGNS LIST

1A first unit, 1B second unit, 3 pump (hydraulic pressure source), 5 master cylinder, 6 stroke simulator, 8 housing, 21 shutoff valve (normally-open electromagnetic valve, electromagnetic shutoff valve), 21-1 coil (second electromagnetic coil), 21-2 cylinder (cup-shaped member), 21-4 plunger (second movable member), 21-4b tip part (second valve body), 21-5 valve body (fixed member), 21-6 seat member (third member), 21-6e first communication hole (third passage hole), 21-6i opening (third opening), 21-7 body member (fourth member), 21-7e second communication hole (fourth passage hole), 21-7f circulation hole (second through hole), 21-7h opening (fourth opening), 21-14 valve part (second valve part), 21-15 electromagnetic drive part (second electromagnetic drive part), 27 SS/V IN (normally-closed electromagnetic valve, electromagnetic switching valve), 27-1 coil (first electromagnetic coil), 27-2 cylinder (tubular member), 27-4 armature (first movable member), 27-4b valve body (first valve body), 27-6 seat member (first member), 27-6e first communication hole (first passage hole), 27-6i opening (first opening), 27-7 body member (second member), 27-7e second communication hole (second passage hole), 27-7f circulation hole (first through hole), 27-7h opening (second opening), 27-14 valve part (first valve part), 27-15 electromagnetic drive part (first electromagnetic drive part), 100 brake pedal (brake operation member), W/C wheel cylinder

1. A hydraulic pressure control device, comprising:
a housing, which internally includes an oil passage;
a normally-closed electromagnetic valve, which includes a first valve part arranged so as to extend from a surface of the housing to an inside of the housing, and is configured to close the oil passage when a current is not supplied; and
a normally-open electromagnetic valve, which includes a second valve part being arranged so as to extend from the surface of the housing to the inside of the housing and having an axial length set to be equal to an axial length of the first valve part, and is configured to open the oil passage when a current is not supplied.

2. A hydraulic pressure control device according to claim 1, wherein the housing has:
a first hole part, in which the first valve part is arranged; and
a second hole part, which is set to be equal to the first hole part in depth from the surface of the housing, and in which the second valve part is arranged.

3. A hydraulic pressure control device according to claim 2, wherein both the first hole part and the second hole part are formed so as to extend from one surface of the housing to the inside of the housing.

4. A hydraulic pressure control device according to claim 3, wherein the first valve part and the second valve part include common portions having common shapes.

5. A hydraulic pressure control device according to claim 4,
wherein the first valve part includes:
a first member, which is formed into a bottomed tubular shape having a first opening opened at one end, and has a first passage hole formed in a bottom wall along an axial direction, and used to open/close the oil passage; and
a second member, which is formed into a bottomed tubular shape having a second opening opened at one end, is fixed to the first opening from the second opening side in the axial direction, and has a second passage hole being formed in a bottom wall, and communicating with the first passage hole in the axial direction, and at least one first through hole formed in a peripheral wall along a radial direction,
wherein the second valve part includes:
a third member, which is formed into a bottomed tubular shape having a third opening opened at one end, and has a third passage hole formed in a bottom wall along the axial direction, and used to open/close the oil passage; and
a fourth member, which is formed into a bottomed tubular shape having a fourth opening opened at one end, is fixed from the fourth opening side to the third opening in the axial direction, and has a fourth passage hole being formed in a bottom wall, and communicating with the third passage hole in the axial direction, and at least one second through hole formed in a peripheral wall along the radial direction, and
wherein the common portions are formed of a shape of a portion of the first member other than the first opening and a shape of a portion of the third member other than the third opening.

6. A hydraulic pressure control device according to claim 5, wherein the common portions are formed of a shape of a portion of the second member other than the second opening and a shape of a portion of the fourth member other than the fourth opening.

7. A hydraulic pressure control device according to claim 6,
wherein the normally-closed electromagnetic valve includes a first electromagnetic drive part including:
a first electromagnetic coil, which is provided so as to extend from one surface of the housing to an outside of the housing, and is configured to generate an electromagnetic force when a current is supplied;
a tubular member, which is made of a non-magnetic material, is arranged on an inner periphery of the first electromagnetic coil, and is connected to the second opening side of the second member at the first valve part; and
a first movable member, which is formed of a magnetic body, is movably provided on an inner periphery of the tubular member, moves in the axial direction through an attraction force of the first electromagnetic coil, and includes a first valve body used to open/close the first passage hole on a tip side, and
wherein the normally-open electromagnetic valve includes a second electromagnetic drive part including:
a second electromagnetic coil, which is provided so as to extend from the one surface of the housing to the outside of the housing, and is configured to generate an electromagnetic force when a current is supplied;
a fixed member, which is made of a magnetic material, is arranged on an inner periphery of the second electromagnetic coil, and is connected to a bottom wall side of the third member at the second valve part;
a cup-shaped member, which is made of a non-magnetic material, is arranged on the inner periphery of the second electromagnetic coil, and accommodates one end of the fixed member; and
a second movable member, which is formed of a magnetic body, is movably provided on an inner periphery of the cup-shaped member, moves in the axial direction through an attraction force of the second electromagnetic coil, and includes a second valve body used to open/close the third passage hole on a tip side.

8. A hydraulic pressure control device according to claim 6, wherein the first member, the second member, the third member, and the fourth member are formed through press forming.

9. A hydraulic pressure control device according to claim 3, wherein the first hole part and the second hole part are arranged so as to be adjacent to each other, and an oil passage configured to connect the first hole part and the second hole part to each other of the oil passage is arranged along the one surface of the housing.

10. A hydraulic pressure control device according to claim 3,
wherein the normally-closed electromagnetic valve includes a first electromagnetic drive part including a first electromagnetic coil, which is provided so as to extend from the surface of the housing to an outside of the housing, and is configured to generate an electromagnetic force through a current supply, and
wherein the normally-open electromagnetic valve includes a second electromagnetic drive part including a second electromagnetic coil, which is provided so as to extend from the surface of the housing to the outside of the housing, is configured to generate an electromagnetic force through a current supply, and has an axial length set to be equal to an axial length of the first electromagnetic coil.

11. A hydraulic pressure control device according to claim 1,
wherein the first valve part includes:
a first member, which is formed into a bottomed tubular shape having a first opening opened at one end, and has a first passage hole formed in a bottom wall along an axial direction, and used to open/close the oil passage; and
a second member, which is formed into a bottomed tubular shape having a second opening opened at one end, is fixed to the first opening from the second opening side in the axial direction, and has a second passage hole being formed in a bottom wall, and communicating with the first passage hole in the axial direction, and at least one first through hole formed in a peripheral wall along a radial direction,
wherein the second valve part includes:
a third member, which is formed into a bottomed tubular shape having a third opening opened at one end, and has a third passage hole formed in a bottom wall along the axial direction, and used to open/close the oil passage; and
a fourth member, which is formed into a bottomed tubular shape having a fourth opening opened at one end, is fixed to the third opening from the fourth opening side in the axial direction, and has a fourth passage hole being formed in a bottom wall, and communicating with the third passage hole in the axial direction, and at least one second through hole formed in a peripheral wall along the radial direction,
wherein common shapes are formed of a shape of a portion of the first member other than the first opening and a shape of a portion of the third member other than the third opening, and
wherein common shapes are formed of a shape of a portion of the second member other than the second opening and a shape of a portion of the fourth member other than the fourth opening.

12. A hydraulic pressure control device according to claim 11,
wherein the normally-closed electromagnetic valve includes a first electromagnetic drive part including:
a first electromagnetic coil, which is provided so as to extend from the surface of the housing to an outside of the housing, and is configured to generate an electromagnetic force when a current is supplied;
a tubular member, which is made of a non-magnetic material, is arranged on an inner periphery of the first electromagnetic coil, and is connected to the second opening side of the second member at the first valve part; and
a first movable member, which is formed of a magnetic body, is movably provided on an inner periphery of the tubular member, moves in the axial direction through an attraction force of the first electromagnetic coil, and includes a first valve body used to open/close the first passage hole on a tip side, and
wherein the normally-open electromagnetic valve includes a second electromagnetic drive part including:
a second electromagnetic coil, which is provided so as to extend from the surface of the housing to the outside of the housing, and is configured to generate an electromagnetic force when a current is supplied;
a fixed member, which is made of a magnetic material, is arranged on an inner periphery of the second electromagnetic coil, and is connected to a bottom wall side of the third member at the second valve part;
a cup-shaped member, which is made of a non-magnetic material, is arranged on the inner periphery of the second electromagnetic coil, and accommodates one end of the fixed member; and
a second movable member, which is formed of a magnetic body, is movably provided on an inner periphery of the cup-shaped member, moves in the axial direction through an attraction force of the second electromagnetic coil, and includes a second valve body used to open/close the third passage hole on a tip side.

13. A hydraulic pressure control device, comprising:
a housing, which internally includes an oil passage;
a normally-closed electromagnetic valve, which includes a first valve part arranged so as to extend from a surface of the housing to an inside of the housing, and is configured to close the oil passage when a current is not supplied; and
a normally-open electromagnetic valve, which includes a second valve part being arranged so as to extend from the surface of the housing to the inside of the housing, having an axial length set to be equal to an axial length of the first valve part through inclusion of a common portion having a shape common to the first valve part, and is configured to open the oil passage when a current is not supplied.

14. A hydraulic pressure control device according to claim 13, wherein the housing has:
a first hole part, in which the first valve part is arranged; and
a second hole part, which is set to be equal to the first hole part in depth from the surface of the housing, and in which the second valve part is arranged.

15. A hydraulic pressure control device according to claim 14, wherein both the first hole part and the second hole part are formed so as to extend from one surface of the housing to the inside of the housing.

16. A braking system, comprising:
a first unit including:
a master cylinder, which is configured to generate a brake hydraulic pressure through a brake operation of a driver; and
a stroke simulator, into which brake fluid flowed out from the master cylinder flows, and which is configured to generate a simulated operation reaction force of a brake operation member; and
a second unit integrally including:
a housing, which is connected to the first unit, and internally includes an oil passage;
a hydraulic pressure source, which is provided inside the housing, and is configured to generate an operation hydraulic pressure for a wheel cylinder provided to a wheel via the oil passage;
an electromagnetic switching valve, which is a normally-closed electromagnetic valve including a first valve part arranged so as to extend from a surface of the housing to an inside of the housing, and being configured to close when a current is not supplied, and is configured to permit an inflow of the brake fluid into the stroke simulator;
an electromagnetic shutoff valve, which is a normally-open electromagnetic valve including a second valve part being arranged so as to extend from the surface of the housing to the inside of the housing, having an axial length set to be equal to an axial length of the first valve part, and being configured to open when a current is not supplied, and is configured to switch a communication state of an oil passage between the master cylinder and the wheel cylinder; and
a control unit, which is configured to drive the hydraulic pressure source, the electromagnetic shutoff valve, and the electromagnetic switching valve.

17. A braking system according to claim 16, wherein the housing has:
a first hole part, in which the first valve part is arranged; and
a second hole part, which is set to be equal to the first hole part in depth from the surface of the housing, and in which the second valve part is arranged.

18. A braking system according to claim 17, wherein both the first hole part and the second hole part are formed so as to extend from one surface, to which the control unit is mounted, of the housing to the inside of the housing.
